(19) United States
(12) Patent Application Publication
(10) Pub. No.: US 2024/0344170 A1
(43) Pub. Date: Oct. 17, 2024

(54) METHODS FOR RECOVERING CRITICAL ELEMENTS FROM LEACH SOLUTIONS

(71) Applicant: Virginia Tech Intellectual Properties Inc., Blacksburg, VA (US)

(72) Inventors: Rick HONAKER, Lexington, KY (US); Wencai ZHANG, Blacksburg, VA (US); Li QI, Blacksburg, VA (US)

(21) Appl. No.: 18/754,886

(22) Filed: Jun. 26, 2024

Related U.S. Application Data
(63) Continuation of application No. PCT/US2023/060163, filed on Jan. 5, 2023.
(60) Provisional application No. 63/266,414, filed on Jan. 5, 2022.

(51) Int. Cl. C22B 3/44; C22B 3/00; C22B 3/22; C22B 3/38; C22B 47/00

(52) U.S. Cl. CPC C22B 3/44; C22B 3/22; C22B 3/381; C22B 3/3842; C22B 23/0461; C22B 47/00

(57) ABSTRACT

Methods for separating and recovering Mn, Co, and Ni from leach solutions include selectively recovering and producing high purity products of Mn, Co, and Ni from leach solutions, combining staged precipitation, sulfide precipitation, and solvent extraction to separate contaminants from the leach solution to isolate and recover Mn, Co, and Ni in high yield and purity.

### CROSS REFERENCE TO RELATED APPLICATIONS

This application is a continuation of PCT/US2023/060163, filed Jan. 5, 2023, which claims the benefit of U.S. Provisional Application No. 63/266,414 filed on Jan. 5, 2022, both of which are fully incorporated herein by reference.

### STATEMENT REGARDING FEDERALLY SPONSORED RESEARCH OR DEVELOPMENT

This invention was made with government support under grant number DE-FE0031827, awarded by the Department of Energy. The government has certain rights in the invention.

### BACKGROUND

The demand for certain elements, such as Mn, Co, and Ni, has surged in recent years due to the rapid growth of battery production for electric vehicles and utility-scale energy storage (Omelchuk et al., 2017). However, the United States is heavily dependent on imports from foreign countries to meet the domestic demand for these elements; for example, as reported by Burger et al. (2018), the United States had a net import reliance as a percentage of apparent consumption of 72% for Co in 2017. The U.S. Department of the Interior published a list of critical mineral commodities in 2018, including Mn and Co (Petty, 2018). Ni is also regarded as a critical element by the U.S. Department of Energy due to its importance to clean energy technologies (US DOE, 2021). Therefore, it is necessary to establish supply chains of these critical mineral commodities in the United States by recovering from secondary resources.

Acid mine drainage (AMD) is automatically generated in the natural environment due to the oxidation of sulfide minerals, particularly pyrite, in the presence of oxygen and water. The details of the formation and origin of AMD have been extensively discussed in the literature (Akcil and Koldas, 2006; Skousen et al., 2019). AMD normally has high acidity, elevated concentrations of potentially toxic metal ions, and high sulfate content, thus posing severe pollution problems to current and future generations. The release of untreated AMD to the natural environment causes risks of contaminating nearby water sources and sediments with detrimental effects on biodiversity. On the other hand, the acidic nature of AMD contributes to the appearance of valuable elements, making AMD an alternative resource for metal recovery. The recovery of valuable elements, such as rare earth elements, Cu, Zn, and Mn, from AMD has been reported in the literature, and common recovery methods include electrochemical reactions, chemical precipitation, adsorption, etc. (Ayora et al., 2016; Chen et al., 2014; Larsson et al., 2018; Motsi et al., 2009; Oh et al., 2016; Park et al., 2015a; Pozo et al., 2017; Seo et al., 2017). However, in most existing studies, the valuable elements existing in AMD were recovered as mixtures (Park et al., 2015b), and process circuits for generating individually separated, high-purity products of valuable elements, particularly Mn, Co, and Ni, from AMD have rarely been reported (Zhang and Honaker, 2018).

### SUMMARY

Described herein are methods for separating and recovering Mn, Co, and Ni from leach solutions. In one aspect, the methods selectively recover and produce high purity products of Mn, Co, and Ni from leach solutions, combining staged precipitation, sulfide precipitation, and solvent extraction to separate contaminants from the leach solution.

Other methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a flow diagram of the process used to generate and re-dissolve the pre-concentrate rich in critical elements.

FIGS. 2A-2B show (a) precipitation recoveries of the contaminant and valuable elements from the AMD, and (b) elemental contents of the precipitates generated from the staged precipitation test.

FIG. 3 shows the exemplary procedures used for optimizing staged precipitation.

FIGS. 4A-4C show contaminant and valuable element recoveries in the different steps of the three tests shown in FIG. 3 ((a) to (c) present recovery values obtained in the first, second, and third steps, respectively).

FIG. 5 shows the elemental contents of a pre-concentrate produced herein obtained in the pH range of 6.50 to 10.00.

FIG. 6 shows the elemental concentrations of a pre-concentrated slurry produced herein.

FIG. 7 shows the dissolution recovery of Mn, Co, Zn, Ni, and Al in a pre-concentrated slurry produced herein.

FIGS. 8A-8B show the (a) elemental concentrations of a dissolved solution produced herein and (b) elemental contents of the undissolved solid residue.

FIGS. 9A-9D show the effects of the molar ratio of sulfur to metal (k) on the recovery of (a) Mn, (b) Co, (c) Ni, and (d) Zn (pH=3.00±0.05).

FIGS. 10A-10D show the effects of pH on the recovery of (a) Mn, (b) Co, (c) Ni, and (d) Zn (k=1).

FIG. 11 shows the effects of calcination temperature on the dissolubility of the sulfide precipitate (1.2 M HCl, 1% solid content, 2 h reaction time).

FIG. 12 shows the XRD patterns of the as-synthesized and 200° C.-calcined sulfide precipitates.

FIGS. 13A-13B show the SEM images (left) and EDS spectra (right) of (a) as-synthesized and (b) 200° C.-calcined sulfide precipitate.

FIG. 14 shows the elemental concentrations of the solution prepared by dissolving the calcined sulfide precipitate (1.2 M HCl, 1% solid content, 2 h reaction time).

FIG. 15 shows the effects of equilibrium pH on the extraction of Mn, Co, Ni, and Zn using D2EHPA (C_{D2EHPA}=0.135 M, A/O=1).

FIG. 16 shows the effects of equilibrium pH on the extraction of Mn, Co, and Ni using Cyanex 272 (C_{Cyanex 272}=0.135 M, A/O=1).

FIGS. 17A-17B show elemental concentrations of (a) the aqueous phase after two-stage solvent extraction and (b) the stripping solution of the loaded organic phase generated in the second stage solvent extraction.

FIG. 18 shows an exemplary flowsheet for generating high-purity products of certain critical elements (i.e., Mn, Co, and Ni) from AMD.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used in the specification and the appended claims, the singular forms “a,” “an” and “the” include plural referents unless the context clearly dictates otherwise. Thus, for example, reference to “a fluorinated ring monomer,” “a comonomer,” or “a copolymer,” include, but are not limited to, mixtures or combinations of two or more such fluorinated ring monomers, comonomers, or copolymers, and the like.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl. Fused aryl groups including, but not limited to, indene and naphthalene groups are also contemplated.

The term “leach solution” as used herein is metal-laden water. In one aspect, the leach solution is acidic metal-laden water generated from techniques such as, for example, stockpile leaching and heap leaching. In one aspect, the leach solution comprises clean coal leachate, coal refuse leachate, acid mine drainage, or a solution comprising a matrix as the coal-based leachate. The leach solution is also referred to as pregnant leach solution or pregnant liquor Solution (PLS).

The term “enriched” as used herein the relative amount of a component present in a final composition when compared to the amount of the same component in an initial composition, where the amount of the component in the final composition is greater than the amount of the same component present in the initial composition.

The term “manganese ions” as used herein refers to ions that are produced from a manganese compound when solubilized in water or other solvents produces. The manganese ions can have an oxidation state of II, III, IV, or a combination thereof. In one aspect, the manganese compound can be a manganese salt or oxide.

The term “nickel ions” as used herein refers to ions that are produced from a nickel compound when solubilized in water or other solvents produces. The nickel ions can have an oxidation state of II, IV, or a combination thereof. In one aspect, the nickel compound can be a nickel salt or oxide.

The term “cobalt ions” as used herein refers to ions that are produced from cobalt compound when solubilized in water or other solvents produces. The cobalt ions can have an oxidation state of II, III, or a combination thereof. In one aspect, the cobalt compound can be a cobalt salt or oxide.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

All percentages herein are by volume unless otherwise stated. Unless otherwise specified, temperatures referred to herein are based on atmospheric pressure (i.e. one atmosphere).

Described herein are methods for separating and recovering Mn, Co, and Ni from leach solutions. In one aspect, the methods selectively recover and produce high purity products of Mn, Co, and Ni from leach solutions, combining staged precipitation, sulfide precipitation, and solvent extraction to separate contaminants from the leach solution. Process steps and conditions for performing the methods described herein are provided below.

Methods for Recovering Manganese Ions from a Leach Solution

In one aspect, manganese ions can be removed or recovered from a leach solution by performing a series of alkaline base precipitation steps. In one aspect, the method involves
(a) optionally mixing the leach solution with an oxidant to produce a first composition;
(b) adding a base to the first composition or to the leach solution to produce a second composition having a pH of from about 3.0 to about 4.5, wherein the second composition comprises a second supernatant and a second precipitate;
(c) separating the second supernatant from the second composition;
(d) adding a base to the second supernatant to produce a third composition having a pH of from about 6 to about 7, wherein the third composition comprises a third supernatant and a third precipitate;
(e) separating the third supernatant from the third composition;
(f) adding a base to the third supernatant to produce a fourth composition having a pH of from about 9.5 to about 10.5, wherein the fourth composition comprises a fourth supernatant and a fourth precipitate;
(g) separating the fourth precipitate from the fourth composition;
(h) adding an acid to the fourth precipitate to produce a fifth composition having a pH of from about 4.5 to about 5.5, wherein the fifth composition comprises a fifth supernatant and a fifth precipitate; and
(i) separating the fifth precipitate from the fifth composition, wherein the fifth precipitate is enriched with manganese ions.

By varying the amount of base and pH of the solutions, manganese ions can be selectively removed from the leach solution. In one aspect, the base comprises an alkali metal hydroxide or alkaline earth hydroxide. In one aspect, the base comprises an alkali metal hydroxide, ammonium hydroxide, or a combination thereof. In another aspect, the base comprises sodium hydroxide, potassium hydroxide, sodium carbonate, lime, or any combination thereof. In another aspect, the base has a concentration of from about 1 M to about 10 M, or about 1 M, 1.5 M, 2 M, 2.5 M, 3 M, 3.5 M, 4 M, 4.5 M, 5 M, 6 M, 6.5 M, 7 M, 7.5 M, 8 M, 8.5 M, 9 M, 9.5 M, or 10 M, where any value can be a lower and upper end-point of a range (e.g., about 5.5 M to about 8 M). In another aspect, the base comprises sodium hydroxide at a concentration of about 4 M to 6 M.

In one aspect, the amount of base added in step (b) is sufficient to produce a pH of from about 3.0 to about 4.5, or 3.0, 3.2, 3.4, 3.6, 3.8, 4.0, 4.2, 4.4, or 4.5, where any value can be a lower and upper end-point of a range (e.g., about 3.8 to about 4.2). In another aspect, the amount of base added in step (d) is sufficient to produce a pH of from about 6.0 to about 7.0, or 6.1, 6.2, 6.3, 6.4, 6.5, 6.6, 6.7, 6.8, 6.9, or 7.0, where any value can be a lower and upper end-point of a range (e.g., about 6.2 to about 6.8). In another aspect, the amount of base added in step (f) is sufficient to produce a pH of from about 9.5 to about 10.5, or 9.5, 9.6, 9.7, 9.8, 9.9, 10.0, 10.1, 10.2, 10.3, 10.4, or 10.5, where any value can be a lower and upper end-point of a range (e.g., about 9.7 to about 10.3).

After performing the base precipitation steps, the resulting precipitate is mixed with an acid to further increase the amount of recovered manganese ions. In one aspect, the acid comprises hydrochloric acid, sulfuric acid, phosphoric acid, nitric acid, or any combination thereof. In another aspect, the acid has a concentration of from about 5 M to about 15 M, or about 5 M, 5.5 M, 6 M, 6.5 M, 7 M, 7.5 M, 8 M, 8.5 M, 9 M, 9.5 M, 10 M, 10.5 M, 11.0 M, 11.5 M, 12 M, 12.5 M, 13 M, 13.5 M, 14 M, 14.5 M, or 15 M, where any value can be a lower and upper end-point of a range (e.g., about 10.0 M to about 13.0 M). In another aspect, the acid is hydrochloric acid having a concentration of from about 10 M to 13 M. In another aspect, the amount of acid added in step (h) is sufficient to produce a pH of from about 4.0 to about 6.0, or 4.0, 4.2, 4.4, 4.6, 4.8, 5.0, 5.2, 5.4, 5.6, 5.8, or 6.0, where any value can be a lower and upper end-point of a range (e.g., about 4.8 to about 5.4).

In certain aspects, the leach solution can be mixed with an oxidant prior to step (a). In one aspect, the oxidant comprises hydrogen peroxide or oxygen. The amount of oxidant can vary depending upon the amount manganese present in the leach solution.

Steps (b), (d), (f), and (h) that involve the addition of a base and acid with subsequent mixing can be performed using techniques known in the art. In another aspect, steps (c), (e), (g), and (i), where a precipitate is separated, can be performed by centrifugation, filtration, or other solid/liquid separation methods known in the art. In another aspect, the process can be performed under batch or continuous conditions or systems. FIG. 18 (process on left side) as well as the Examples provide exemplary procedures for isolating manganese ions using the process as described herein.

After the process is complete (i.e., after step (h)), the isolated precipitate is enriched with manganese ions. In one aspect, the precipitate is composed of manganese compounds (i.e., manganese ions) having a purity of greater than 80%, greater than 85%, greater than 90%, greater than 95%, or greater than 99%.

Methods for Recovering Nickel Ions from a Leach Solution

In one aspect, nickel ions can be removed or recovered from a leach solution by performing a sulfide precipitation step. Traditionally, the separation of Co and Ni cannot be achieved by sulfide precipitation. The adjacent positions of Co and Ni in the transition metal series in the periodic table result in similar precipitation characteristics. The methods described herein address this shortcoming.

In one aspect, the method involves
(a) mixing the fifth supernatant produced by the method in any one of claims 1-14 with a sulfide source to produce a sixth composition comprising a sixth supernatant and a sixth precipitate;
(b) separating the sixth precipitate from the sixth composition;
(c) calcining the sixth precipitate;
(d) dissolving the sixth precipitate in an acid to produce a seventh composition;
(e) extracting the seventh composition with a first extractant to produce an eighth composition comprising a first aqueous phase and a first organic phase;
(f) separating the first aqueous phase from the eighth composition;
(g) adding a base to the first aqueous phase to produce a tenth composition, wherein the tenth composition comprises a tenth supernatant and a tenth precipitate;
(h) separating the tenth precipitate from the tenth composition, wherein the tenth precipitate is enriched with nickel ions.

The fifth supernatant is composition comprising nickel ions. In one aspect, the fifth supernatant produced by the method above for isolating manganese ions is enriched with nickel and cobalt compounds can be used in the methods above for removing nickel ions. In one aspect, the process for removing manganese ions can be continuous with the process for removing nickel ions (i.e., the fifth supernatant produced by the method above for isolating manganese ions can be fed into the process for recovering nickel ions). In another aspect, the fifth supernatant can be produced and nickel ions can be removed using the process above at a later time.

In one aspect, the sulfide source comprises an alkali metal sulfide or an alkaline earth sulfide. In one aspect, the sulfide source is sodium sulfide. The amount of sulfide source used in step (a) can vary depending upon the amount of nickel and cobalt ions present in the solution. In one aspect, the sulfide source is in a molar ratio of from about 0.5:1 to about 1.5:1 sulfide source to critical metal ions (i.e., nickel ions and cobalt ions), or about 0.5:1, 0.6:1, 0.7:1, 0.8:1, 0.9:1, 1.0:1, 1.2:1, 1.3:1, 1.4:1, or 1.5:1, where any value can be a lower and upper end-point of a range (e.g., about 0.7:1 to about 1.2:1). In another aspect, the pH of the solution with the sulfide source is from about 3.5 to about 4.5, or 3.5, 3.6, 3.7, 3.8, 3.9, 4.0, 4.1, 4.2, 4.3, 4.4, or 4.5, where any value can be a lower and upper end-point of a range (e.g., about 3.8 to about 4.4).

After the sulfide source is added, a precipitate is formed and isolated (step (b)). In one aspect, the precipitate is calcined at a temperature of from about 100° C. to about 500° C. (step (c)), or about 100° C., 150° C., 200° C., 250° C., 300° C., 350° C., 400° C., 450° C., or 500° C., where any value can be a lower and upper end-point of a range (e.g., about 150° C. to about 250° C.). In another aspect, the precipitate is calcined from 0.5 hours to 12 hours.

The calcined precipitate is next dissolved in an acid (step (d)). In one aspect, the acid comprises hydrochloric acid, sulfuric acid, phosphoric acid, nitric acid, or any combination thereof. In another aspect, the acid has a concentration of from about 0.5 M to about 5 M, or about 0.5 M, 1 M, 1.5 M, 2 M, 2.5 M, 3 M, 3.5 M, 4 M, 4.5 M, or 5 M, where any value can be a lower and upper end-point of a range (e.g., about 0.5 M to about 2 M). In another aspect, the acid is hydrochloric acid having a concentration of from about 0.5 M to 5 M.

The aqueous composition produced in step (d) is next extracted with an extractant (step (e)). In one aspect, the extractant is mixed with an organic solvent prior to extraction. Upon mixing the extractant in organic solvent with the aqueous composition produced in step (d), an aqueous phase and organic phase are produced. In one aspect, the pH of the solution with the phosphate compound is from about 3.0 to about 4.0, or 3.0, 3.1, 3.2, 3.3, 3.4, 3.5, 3.6, 3.7, 3.8, 3.9, or 4.0, where any value can be a lower and upper end-point of a range (e.g., about 3.2 to about 3.6).

In one aspect, the first extractant comprises an organic compound. In another aspect, the first extractant is an alkyl phosphate or an aryl phosphate. In another aspect, the first extractant comprises an alkyl phosphinic acid or an aryl phosphinic acid. In another aspect, the first extractant comprises an alkyl phosphine oxide or an aryl phosphine oxide. In one aspect, the first extractant comprises bis(2,4,4-trimethylpentyl) phosphinic acid, bis(2,4,4-trimethylpentyl)dithiophosphinic acid, trioctylphosphine oxide, dioctylmonohexylphosphine oxide, dihexylmonooctylphosphine oxide, trihexylphosphine oxide, bis-(2,4,4-trimethylpentyl) monothiophosphinic acid, di-(2-ethylhexyl) phosphinic acid, 2-ethylhexyl 2-ethylhexyphosphonic acid, neodecanoic acid, or any combination thereof.

In one aspect, the extractant has a concentration of from about 0.1 M to about 2 M, or about 0.01 M, 0.025 M, 0.05 M, 0.075 M, 0.10 M, 0.125 M, 0.15 M, 0.175 M, or 0.20 M, where any value can be a lower and upper end-point of a range (e.g., about 0.05 M to about 0.2 M). The organic solvent selected to form the solution of the extractant compound can vary. In one aspect, the organic solvent is a hydrocarbon (e.g., kerosene).

After step (e), an aqueous phase and organic phase are formed. The aqueous phase is separated (step (f)) and further processed. The aqueous phase is next mixed with a base, which produces a precipitate enriched with nickel ions (step (i)). In one aspect, the base comprises an alkali metal hydroxide or alkaline earth hydroxide. In one aspect, the base comprises an alkali metal hydroxide, ammonium hydroxide, or a combination thereof. In another aspect, the base comprises sodium hydroxide, potassium hydroxide, sodium carbonate, lime, or any combination thereof. In one aspect, the amount of base added in step (b) is sufficient to produce a pH of from about 9.5 to about 10.5, or 9.5, 9.6, 9.7, 9.8, 9.9, 10.0, 10.1, 10.2, 10.3, 10.4, or 10.5, where any value can be a lower and upper end-point of a range (e.g., about 9.8 to about 10.2).

Steps that involve the addition of a sulfide source, acid, base, and extractant with subsequent mixing can be performed using techniques known in the art. In another aspect, steps (b) and (j), where a precipitate is separated, can be performed by centrifugation, filtration, or other solid/liquid separation methods known in the art. In another aspect, the process can be performed under batch or continuous conditions or systems. FIG. 18 (center process) as well as the Examples provide exemplary procedures for isolating nickel ions using the process as described herein.

After the process is complete (i.e., after step (j)), the isolated precipitate is enriched with nickel ions. In one aspect, the precipitate is composed of nickel compounds (i.e., nickel ions) having a purity of greater than 80%, greater than 85%, greater than 90%, greater than 95%, or greater than 99%.

In another aspect, the method for recovering nickel ions involves
(a) mixing the fifth supernatant with a sulfide source to produce a sixth composition comprising a sixth supernatant and a sixth precipitate;
(b) separating the sixth precipitate from the sixth composition;
(c) calcining the sixth precipitate;
(d) dissolving the sixth precipitate in an acid to produce a seventh composition;
(e) extracting the seventh composition with a first extractant to produce an eighth composition comprising a first aqueous phase and a first organic phase;
(f) separating the first aqueous phase from the eighth composition;
(g) extracting the first aqueous phase with a second extractant to produce a ninth composition comprising a second aqueous phase and a second organic phase;
(h) separating the second aqueous phase from the ninth composition;
(i) adding a base to the second aqueous phase to produce a tenth composition, wherein the tenth composition comprises a tenth supernatant and a tenth precipitate;
(j) separating the tenth precipitate from the tenth composition, wherein the tenth precipitate is enriched with nickel ions.

The method above involves two extractions steps (e) and (g). The first extractant and second extractant can be the same compound or different compounds. The extractants provide above can be used as the first and second extractants.

In one aspect, the first extractant and second extractant each has a concentration of from about 0.1 M to about 2 M, or about 0.01 M, 0.025 M, 0.05 M, 0.075 M, 0.10 M, 0.125 M, 0.15 M, 0.175 M, or 0.20 M, where any value can be a lower and upper end-point of a range (e.g., about 0.05 M to about 0.2 M). The organic solvent selected to form the solution of the extractant compound can vary. In one aspect, the organic solvent is a hydrocarbon (e.g., kerosene). In one aspect, the first extractant is bis(2-ethylhexyl) phosphate (D2EHPA) and the second extractant is bis(2,4,4-trimethylpentyl) phosphinic acid (Cyanex 272).

Methods for Recovering Cobalt Ions from a Leach Solution

In one aspect, cobalt ions can be removed or recovered from a leach solution by performing a sulfide precipitation step. Traditionally, the separation of Co and Ni cannot be achieved by sulfide precipitation. The adjacent positions of Co and Ni in the transition metal series in the periodic table result in similar precipitation characteristics. The methods described herein address this shortcoming.

In one aspect, the method involves
(a) mixing the second organic phase produced by the method for isolating nickel ions with an acid to produce an eleventh composition;
(b) mixing the eleventh composition with a sulfide source to produce a twelfth composition comprising a twelfth supernatant and a twelfth precipitate; and
(c) separating the twelfth precipitate from the twelfth composition, wherein the twelfth precipitate is enriched with cobalt ions.

The second organic phase produced by the method above for isolating nickel ions is enriched with cobalt compounds. In step (a), the second organic phase is mixed with an aqueous acid. In one aspect, the acid comprises hydrochloric acid, sulfuric acid, phosphoric acid, nitric acid, or any combination thereof. In another aspect, the acid has a concentration of from about 0.1 M to about 1 M, or about 0.1 M, 0.2 M, 0.3 M, 0.4 M, 0.5 M, 0.6 M, 0.7 M, 0.8 M, 0.9 M, or, 1.0 M, where any value can be a lower and upper end-point of a range (e.g., about 0.2 M to about 0.7 M).

After step (a), an aqueous phase and organic phase are formed. The aqueous phase is separated from the organic phase (step (b)). The aqueous phase is next mixed with a sulfide source, which produces a precipitate enriched with cobalt ions (step (c)). In one aspect, the sulfide source comprises an alkali metal sulfide or an alkaline earth sulfide. In one aspect, the sulfide source is sodium sulfide. The amount of sulfide source used in step (c) can vary depending upon the amount of cobalt ions present in the solution. In one aspect, the sulfide source is in a molar ratio of from about 0.5:1 to about 1.5:1 sulfide source to critical metal ions (i.e., cobalt ions), or about 0.5:1, 0.6:1, 0.7:1, 0.8:1, 0.9:1, 1.0:1, 1.2:1, 1.3:1, 1.4:1, or 1.5:1, where any value can be a lower and upper end-point of a range (e.g., about 0.7:1 to about 1.2:1). In another aspect, the pH of the solution with the sulfide source is from about 3.5 to about 4.5, or 3.5, 3.6, 3.7, 3.8, 3.9, 4.0, 4.1, 4.2, 4.3, 4.4, or 4.5, where any value can be a lower and upper end-point of a range (e.g., about 3.8 to about 4.4).

Step (c), where a precipitate is separated, can be performed by centrifugation, filtration, or other solid/liquid separation methods known in the art. In another aspect, the process can be performed under batch or continuous conditions or systems. FIG. 18 (process on right hand side) as well as the Examples provide exemplary procedures for isolating cobalt ions using the process as described herein.

After the process is complete (i.e., after step (c)), the isolated precipitate is enriched with cobalt ions. In one aspect, the precipitate is composed of cobalt compounds (i.e., cobalt ions) having a purity of greater than 80%, greater than 85%, greater than 90%, greater than 95%, or greater than 99%.

In one aspect, the process for removing nickel ions can be continuous with the process for removing cobalt ions (i.e., the second organic phase produced by the method above for isolating nickel ions can be fed into the process for recovering cobalt ions). In another aspect, the second organic phase can be produced and cobalt ions can be removed using the process above at a later time.

Aspect 1. A method for recovering manganese ions from a leach solution, the method comprising:
(a) optionally mixing the leach solution with an oxidant to produce a first composition;
(b) adding a base to the first composition or to the leach solution to produce a second composition, wherein the second composition comprises a second supernatant and a second precipitate;
(c) separating the second supernatant from the second composition;
(d) adding a base to the second supernatant to produce a third composition, wherein the third composition comprises a third supernatant and a third precipitate;
(e) separating the third supernatant from the third composition;
(f) adding a base to the third supernatant to produce a fourth composition, wherein the fourth composition comprises a fourth supernatant and a fourth precipitate;
(g) separating the fourth precipitate from the fourth composition;
(h) adding an acid to the fourth precipitate to produce a fifth composition, wherein the fifth composition comprises a fifth supernatant and a fifth precipitate; and
(i) separating the fifth precipitate from the fifth composition, wherein the fifth precipitate is enriched with manganese ions.
   Aspect 2. The method of Aspect 1, wherein the oxidant comprises hydrogen peroxide or oxygen.
   Aspect 3. The method of Aspect 1 or 2, wherein the base comprises an alkali metal hydroxide or alkaline earth hydroxide.
   Aspect 4. The method in any one of Aspects 1-3, wherein the base comprises sodium hydroxide.
   Aspect 5. The method of Aspect 1, wherein the base comprises sodium hydroxide at a concentration of about 4 M to 6 M.
   Aspect 6. The method in any one of Aspects 1-3, wherein the base has a concentration of from about 1 M to about 10 M.
   Aspect 7. The method in any one of Aspects 1-6, wherein the second composition has a pH of about 3 to about 4.5.
   Aspect 8. The method in any one of Aspects 1-7, wherein the third composition has a pH of about 6 to about 7.
   Aspect 9. The method in any one of Aspects 1-8, wherein the fourth composition has a pH of about 9.5 to about 10.5.
   Aspect 10. The method in any one of Aspects 1-9, wherein the acid comprises hydrochloric acid, sulfuric acid, phosphoric acid, nitric acid, or any combination thereof.
   Aspect 11. The method in any one of Aspects 1-10, wherein the acid has a concentration of from about 5 M to 15 M.
   Aspect 12. The method in any one of Aspects 1-10, wherein the acid is hydrochloric acid having a concentration of from about 10 M to 13 M.
   Aspect 13. The method in any one of Aspects 1-12, wherein steps (c), (e), (g), and (i) are performed by centrifugation, filtration, or other solid/liquid separation methods.
   Aspect 14. The method in any one of Aspects 1-13, wherein the fourth precipitate comprises a slurry.
   Aspect 15. A method for recovering nickel ions from a leach solution, the method comprising:
(a) mixing the fifth supernatant produced by the method in any one of Aspects 1-14 with a sulfide source to produce a sixth composition comprising a sixth supernatant and a sixth precipitate;
(b) separating the sixth precipitate from the sixth composition;
(c) calcining the sixth precipitate;
(d) dissolving the sixth precipitate in an acid to produce a seventh composition;
(e) extracting the seventh composition with a first extractant to produce an eighth composition comprising a first aqueous phase and a first organic phase;
(f) separating the first aqueous phase from the eighth composition;
(g) adding a base to the first aqueous phase to produce a tenth composition, wherein the tenth composition comprises a tenth supernatant and a tenth precipitate;
(h) separating the tenth precipitate from the tenth composition, wherein the tenth precipitate is enriched with nickel ions.
   Aspect 16. The method of Aspect 15, wherein the sulfide source comprises an alkali metal sulfide or an alkaline earth sulfide.
   Aspect 17. The method of Aspect 15 or 16, wherein the sulfide source is in a molar ratio of from about 0.5:1 to about 1.5:1 sulfide source to critical metal ions.
   Aspect 18. The method in any one of Aspects 15-17, wherein the sulfide source is sodium sulfide.
   Aspect 19. The method in any one of Aspects 15-18, wherein the sixth composition has a pH of from about 3.5 to about 4.5.
   Aspect 20. The method in any one of Aspects 15-19, wherein the sixth precipitate is calcined at a temperature of from about 100° C. to about 500° C.
   Aspect 21. The method in any one of Aspects 15-20, wherein the sixth precipitate is dissolved in hydrochloric acid, sulfuric acid, phosphoric acid, nitric acid, or any combination thereof.
   Aspect 22. The method in any one of Aspects 15-21, wherein the first aqueous phase in step (e) has a pH of from about 3 to about 4.
   Aspect 23. The method in any one of Aspects 15-22, wherein the first extractant comprises a phosphate compound.
   Aspect 24. The method in any one of Aspects 15-22, wherein the first extractant comprises an alkyl phosphate or an aryl phosphate.
   Aspect 24. The method in any one of Aspects 15-22, wherein the first extractant comprises an alkyl phosphinic acid or an aryl phosphinic acid.
   Aspect 26. The method in any one of Aspects 15-22, wherein the first extractant comprises an alkyl phosphine oxide or an aryl phosphine oxide.
   Aspect 27. The method in any one of Aspects 15-22, wherein the first extractant comprises bis(2,4,4-trimethylpentyl) phosphinic acid, bis(2,4,4-trimethylpentyl)dithiophosphinic acid, trioctylphosphine oxide, dioctylmonohexylphosphine oxide, dihexylmonooctylphosphine oxide, trihexylphosphine oxide, bis-(2,4,4-trimethylpentyl) monothiophosphinic acid, di-(2-ethylhexyl) phosphinic acid, 2-ethylhexyl 2-ethylhexyphosphonic acid, neodecanoic acid, or any combination thereof.
   Aspect 28. The method in any one of Aspects 15-27, wherein the base comprises an alkali metal hydroxide or alkaline earth hydroxide.
   Aspect 29. The method in any one of Aspects 15-27, wherein the base comprises sodium hydroxide.
   Aspect 30. The method in any one of Aspects 15-29, wherein the amount of base added in step (g) is sufficient to produce a pH of about 9.5 to about 10.5.
   Aspect 31. The method of Aspect 15, comprising
(a) mixing the fifth supernatant with a sulfide source to produce a sixth composition comprising a sixth supernatant and a sixth precipitate;
(b) separating the sixth precipitate from the sixth composition;
(c) calcining the sixth precipitate;
(d) dissolving the sixth precipitate in an acid to produce a seventh composition;
(e) extracting the seventh composition with a first extractant to produce an eighth composition comprising a first aqueous phase and a first organic phase;
(f) separating the first aqueous phase from the eighth composition;
(g) extracting the first aqueous phase with a second extractant to produce a ninth composition comprising a second aqueous phase and a second organic phase;
(h) separating the second aqueous phase from the ninth composition;
(i) adding a base to the second aqueous phase to produce a tenth composition, wherein the tenth composition comprises a tenth supernatant and a tenth precipitate;
(j) separating the tenth precipitate from the tenth composition, wherein the tenth precipitate is enriched with nickel ions.
   Aspect 32. The method of Aspect 31, wherein the sulfide source comprises an alkali metal sulfide or an alkaline earth sulfide.
   Aspect 33. The method of Aspect 31 or 32, wherein the sulfide source is in a molar ratio of from about 0.5:1 to about 1.5:1 sulfide source to critical metal ions.
   Aspect 34. The method in any one of Aspects 31-33, wherein the sulfide source is sodium sulfide.
   Aspect 35. The method in any one of Aspects 31-34, wherein the sixth composition has a pH of from about 3.5 to about 4.5.
   Aspect 36. The method in any one of Aspects 31-35, wherein the sixth precipitate is calcined at a temperature of from about 100° C. to about 500° C.
   Aspect 37. The method in any one of Aspects 31-36, wherein the sixth precipitate is dissolved in hydrochloric acid, sulfuric acid, phosphoric acid, nitric acid, or any combination thereof.
   Aspect 38. The method in any one of Aspects 31-37, wherein the first aqueous phase in step (e) has a pH of from about 3 to about 4.
   Aspect 39. The method in any one of Aspects 31-38, wherein the second aqueous phase in step (g) has a pH of from about 5.0 to about 6.0
   Aspect 40. The method in any one of Aspects 31-39, wherein the base comprises an alkali metal hydroxide or alkaline earth hydroxide.
   Aspect 41. The method in any one of Aspects 31-39, wherein the base comprises sodium hydroxide.
   Aspect 42. The method in any one of Aspects 31-41, wherein the amount of base added in step (i) is sufficient to produce a pH of about 9.5 to about 10.5.
   Aspect 43. The method in any one of Aspects 31-42, wherein the first extractant and the second extractant are the same compound.
   Aspect 44. The method in any one of Aspects 31-42, wherein the first extractant and the second extractant are different compounds.
   Aspect 45. The method in any one of Aspects 31-42, wherein the first extractant and the second extractant comprises a phosphate compound.
   Aspect 46. The method in any one of Aspects 31-42, wherein the first extractant and the second extractant comprises an alkyl phosphate or an aryl phosphate.
   Aspect 47. The method in any one of Aspects 31-42, wherein the first extractant and the second extractant comprises an alkyl phosphinic acid or an aryl phosphinic acid.
   Aspect 48. The method in any one of Aspects 31-42, wherein the first extractant and the second extractant comprises an alkyl phosphine oxide or an aryl phosphine oxide.
   Aspect 49. The method in any one of Aspects 31-42, wherein the first extractant and the second extractant comprises bis(2,4,4-trimethylpentyl) phosphinic acid, bis(2,4,4-trimethylpentyl)dithiophosphinic acid, trioctylphosphine oxide, dioctylmonohexylphosphine oxide, dihexylmonooctylphosphine oxide, trihexylphosphine oxide, bis-(2,4,4-trimethylpentyl) monothiophosphinic acid, di-(2-ethylhexyl) phosphinic acid, 2-ethylhexyl 2-ethylhexyphosphonic acid, neodecanoic acid, or any combination thereof.
   Aspect 50. The method in any one of Aspects 31-42, wherein the first extractant is bis(2-ethylhexyl) phosphate (D2EHPA).
   Aspect 51. The method in any one of Aspects 31-50, wherein the second extractant is bis(2,4,4-trimethylpentyl) phosphinic acid (Cyanex 272).
   Aspect 52. The method in any one of Aspects 31-51, wherein steps (b) and (j) are performed by centrifugation, filtration, or other solid/liquid separation methods.
   Aspect 53. A method for recovering cobalt ions from a leach solution, the method comprising:
(a) mixing the second organic phase produced by the method in any one of Aspects 15-52 with an acid to produce an eleventh composition;
(b) mixing the eleventh composition with a sulfide source to produce a twelfth composition comprising a twelfth supernatant and a twelfth precipitate; and
(c) separating the twelfth precipitate from the twelfth composition, wherein the twelfth precipitate is enriched with cobalt ions.
   Aspect 54. The method of Aspect 53, wherein the acid comprises hydrochloric acid, sulfuric acid, phosphoric acid, nitric acid, or any combination thereof at a concentration of from about 0.1 M to 1 M.
   Aspect 55. The method of Aspect 53 or 54, wherein the sulfide source comprises an alkali metal sulfide or an alkaline earth sulfide.
   Aspect 56. The method in any one of Aspects 53-55, wherein the sulfide source is in a molar ratio of from about 0.5:1 to about 1.5:1 sulfide source to the sum of cobalt ions and manganese ions.
   Aspect 57. The method in any one of Aspects 53-56, wherein the sulfide source is sodium sulfide.
   Aspect 58. The method in any one of Aspects 53-57, wherein the eleventh composition has a pH of from about 3.5 to about 4.5.
   Aspect 59. The method in any one of Aspects 53-58, wherein step (c) performed by centrifugation, filtration, or other solid/liquid separation methods.
   Aspect 60. The method in any one of Aspects 1-59, wherein the leach solution comprises clean coal leachate, coal refuse leachate, acid mine drainage, or a solution comprising a matrix as the coal-based leachate.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric conditions.

### 1. Material and Methods

### 1.1 Materials

An AMD sample of around 400 L was collected from a coal preparation plant that treated run-of-mine bituminous coal of the West Kentucky No. 13 (Baker) seam located in western Kentucky, USA. After delivery to the laboratory, the AMD was filtered using 5 μm pore size filter paper to remove particulate matter. The pH value of the filtrate was measured using a portable pH meter (AP110, Thermo Fisher Scientific, USA). Elemental compositions of the AMD were measured using inductively coupled plasma mass spectrometry (ICP-MS; Thermo Electron X-Series, Thermo Fisher Scientific, USA).

Hydrochloric acid (HCl, 37 wt. %) and sodium hydroxide (NaOH, >97.0 wt. %) were utilized as pH regulators. Hydrogen peroxide (H2O2, 30 wt. %) was used as an oxidizing agent to oxidize ferrous to ferric ions. Hydroxylamine hydrochloride (NH₂OH·HCl, >99 wt. %) was applied as a reducing agent to dissolve oxidized precipitates. Sodium sulfide (Na₂S·9H₂O, >98 wt. %) was used as a precipitant in sulfide precipitation tests. Sulfuric acid (H₂SO₄, 98.08 wt. %) was diluted and used as a strippant in the stripping step of solvent extraction tests. All the chemicals were either certified ACS or trace metal grade, and all solutions were prepared with Type I deionized water with a resistivity of 18.2 MΩ·cm at 25° C. Bis(2-Ethylhexyl) phosphate (D2EHPA, 97 wt. %) and bis(2,4,4-trimethylpentyl) phosphinic acid (Cyanex 272) were provided by Solvay America, Inc. and used as extractants in the solvent extraction tests. Odorless kerosene was used as the diluent of the extractants.

### 1.2 Methods

### 1.2.1 Staged Precipitation Test

Staged precipitation tests were performed on the AMD to investigate the precipitation characteristics of the critical and contaminant elements. The tests were conducted in a 1-L low form Griffin beaker at room temperature. For each test, 0.5 vol. % H₂O₂ was first added into 1 L AMD to oxidize ferrous to ferric ions, and then, the solution was subjected to pH increases by gradually adding 5 M NaOH in 0.2 mL increments. After each addition, the AMD was magnetically stirred at 250 rpm for 2 min to ensure complete dispersion of the base. Precipitates were generated with increases in the pH. After reaching the target pH, the suspension was centrifuged at 5000 rpm for 5 min using a Sorvall™ Legend X1 centrifuge (Thermo Fisher Scientific, USA). Then, the precipitates were collected and dried at 60° C. for 12 h. A small volume of the supernatant was diluted using 5 vol. % HNO₃ and analyzed using ICP-MS. The remaining supernatant was subjected to further pH incremental increases to obtain a series of precipitates produced over a range of pH increments. The precipitation recovery of valuable and contaminant elements were calculated based on elemental concentrations in the feed solution and the supernatants, with considering the dilution effect caused by the incremental NaOH additions and ICP-MS sample collections. The dry precipitates were digested for ICP-MS analysis using a microwave-assisted digestion system. For each sample, 0.1 g material was completely digested with 8 mL aqua regia. The digestion solutions were diluted in 5 vol. % HNO₃ and analyzed using ICP-MS. Elemental concentrations in the digestion solutions were used to back-calculate the elemental content of the precipitates.

### 1.2.2 Re-Dissolution Test

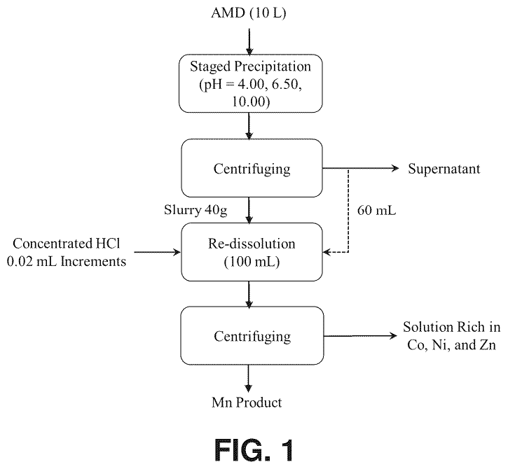

A pre-concentrate of the critical elements obtained through staged precipitation was re-dissolved for purification purposes. The process used to generate and re-dissolve the pre-concentrate is depicted in the flow diagram shown in FIG. 1. H₂O₂ was first added into 10 L AMD to oxidize ferrous to ferric ions. Then, the pH of the solution was increased to 4.00±0.05 by adding NaOH, leading to almost 100% precipitation of Fe. After removing the iron precipitates by filtration, additional NaOH was added to the filtrate to increase the pH to around 6.50±0.05, leading to almost 100% precipitation of Al. The Al precipitates were removed through centrifuging, and then, NaOH was added into the supernatant to increase the pH to 10.00±0.05 to precipitate critical elements. The critical element precipitates were collected through centrifuging, leading to a supernatant and a slurry (around 40 g). The slurry was mixed with a certain volume of the supernatant to achieve a diluted slurry of around 100 mL, which is easier to handle than the original slurry.

Before conducting the re-dissolution tests, 2 mL of the diluted slurry was extracted, and then 1 mL 12 M HCl together with 1 mL 5 M NH₂OH·HCl were added into the extracted sample to dissolve the precipitates completely. The resulting solution was analyzed using ICP-MS. The re-dissolution tests were conducted by mixing the diluted slurry with incremental additions of 12 M HCl. After each addition (0.02 mL), the slurry was mixed for 2 min to stabilize the pH. During the re-dissolution tests, representative samples of the slurry were extracted over a wide pH range of 1.50 to 10.0 using a pipette. The representative samples were centrifuged, and elemental concentrations of the resulting supernatants were analyzed using ICP-MS. Dissolution recovery was calculated based on elemental concentrations of the raw slurry and the supernatants, with considering the dilution effect caused by the incremental HCl additions and representative sample collections. A solution rich in Co, Ni, and Zn was generated from the re-dissolution tests and used as a feedstock for the subsequent sulfide precipitation tests.

### 1.2.3 Sulfide Precipitation Test

Sulfide precipitation tests were performed on the Co, Ni, and Zn-rich solution generated from the re-dissolution tests for purification purposes. The effects of pH (2.00, 3.00, and 4.00), conditioning time (5 min, 10 min, 15 min, 30 min, 45 min, and 60 min), and sulfur to metal molar ratio (0.5, 1, and 2) on the precipitation performance were evaluated. The tests were performed at room temperature, and during the tests, suspension pH was maintained constant by frequently adding diluted HCl and/or NaOH solutions. A sodium sulfide solution of 1 M was prepared and used as the precipitant. Representative samples were collected at different time intervals from the start of the precipitation process up to a total reaction time of 60 min. The solid and liquid fractions of the samples were separated by centrifuging, and the liquid fractions were analyzed using ICP-MS. Sulfur to metal molar ratio (k) was calculated based on the concentration and the molar weight of the valuable elements (i.e., Mn, Co, Ni, and Zn) existing in the feed solution, following the equations below:

$$k = \frac{{n}_{s}}{{n}_{m}} \qquad Eq . ( 2 )$$

$${n}_{s} = {C}_{s} \times {V}_{s} \qquad Eq . ( 3 )$$

$${n}_{m} = \sum \frac{{C}_{i} \times {V}_{f}}{1000 \times {M}_{i}} \qquad Eq . ( 4 )$$

where nₛ and nₘ represent the moles of sulfur and valuable elements, respectively; C_{S} the concentration of sodium sulfide solution (1 M); V_{S} the volume (L) of sodium sulfide solution; Cᵢ the concentration (mg/L) of the valuable elements in the feed solution (i=Mn, Co, Ni, and Zn); V_{f} the volume (L) of feed solution; Mᵢ is the molar mass (g/mol) of the valuable elements. Precipitation recovery of the elements was calculated based on elemental concentrations of the feed solution and the supernatants generated from the tests, with considering the dilution effect caused by HCl and/or NaOH additions and representative sample collections.

### 1.2.4 Sulfide Precipitate Calcination and Dissolution Tests

A bulk sulfide precipitate was produced under the optimum conditions determined in the sulfide precipitation tests. To effectively dissolve the precipitate for further purification, the precipitate was calcinated at different temperatures (i.e., 200° C., 300° C., 400° C., and 500° C.) using a muffle furnace manufactured by Cole-Parmer (EW-33858-80, USA). The precipitate was placed in a ceramic crucible, which was then transferred into the furnace. The predetermined calcination temperatures were reached by elevating from room temperature with a ramping rate of 20° C./min. The sample was calcined at the predetermined temperatures for 2 h. After that, the furnace was automatically cooled to room temperature. To evaluate the effects of calcination, the calcined materials were dissolved under uniform conditions: 25° C. reaction temperature, 2 h reaction time, 1 wt. % solids concentration, 1.2 M HCl, and 500 rpm magnetic stirring. After dissolution, the slurry samples were centrifuged, and the residue solids were dried at 60° C. for 12 h. The dissolubility of the sulfide precipitate was calculated based on the solid weight before and after dissolution. Elemental concentrations in the dissolved solutions were analyzed using ICP-MS.

### 1.2.5 Characterization of Sulfide Precipitate

Mineralogical characterizations of the as-synthesized and calcined sulfide precipitates were conducted through X-ray diffraction (XRD), which was carried out using a Bruker D8 Advance Twin diffractometer along with a Cu X-ray source (Bruker Corporation, USA). The operating voltage and current of the X-ray tube were 40 kV and 40 mA, respectively. Scans were conducted at room temperature from 10° to 70° with a step size of 0.02° 2θ and a step time of 0.05 s. Scanning data was recorded digitally, and peak positions, intensities, and corresponding mineral phases were identified using MDI Jade 6 software.

The precipitates were characterized using scanning electron microscopy—energy dispersive spectroscopy (SEM-EDS). The specimens were prepared by sprinkling the solid particles onto double-sided carbon tape mounted on an SEM stub. A layer of Pt/Pd of 5 nm thickness was coated on the specimens using a desktop sputter coater (Leica ACE600, Leica Microsystems, IL, USA). The characterization was performed using a JSM-IT500HR SEM (JEOL, MA, USA) equipped with an Ultim Max EDS detector (Oxford Instruments, Abingdon, UK). The EDS detector was controlled, and the EDS data was analyzed using AZtech software (Oxford Instruments, Abington, UK). The software provides several different scanning modes for elemental analysis. Map mode was employed in the current study.

### 1.2.6 Solvent Extraction Test

Solvent extraction tests were performed on the solution prepared by dissolving the calcined sulfide precipitate to separate and purify the critical elements. Two commercial extractants, D2EHPA and Cyanex 272, were used as-received without further purification. The organic phase was prepared by dissolving the extractants in kerosene to a desired concentration. The aqueous and organic phases were mixed through magnetic stirring. The extraction behavior of the valuable elements under different equilibrium pH values was investigated. Adjustments in the pH were conducted by introducing NaOH dropwise using a pipette. A concentrated NaOH solution of 19 M was used to minimize changes in the volume of the system. After pH adjustments, the system was continuously stirred for 20 min to reach equilibrium, and then the pH value was recorded as the equilibrium pH. After extraction, the aqueous and organic phases were separated using a separating funnel based on the specific gravity difference between the two phases. The volumetric ratio of aqueous to organic phase (A/O) and the extractant dosage (C_{Solvent}) were fixed at 1 and 0.135 M, respectively, based on the authors' preliminary tests. After extraction, the loaded organic phase was stripped with a 0.3 M H₂SO₄ solution, leading to a pregnant solution. Elemental concentrations in the aqueous solutions obtained from the extraction and stripping steps were measured by ICP-MS. Extraction efficiency was determined based on the elemental concentration difference in the aqueous phase before and after extraction. Stripping recovery was calculated based on the amount of valuable elements in the feed solution of extraction step and the pregnant solution generated from the subsequent stripping step.

### 1.2.7 Production of Final Products

Two pregnant solutions, rich in Ni and Co, respectively, were obtained using a two-stage solvent extraction process. To generate high-purity Ni and Co products, alkaline and sulfide precipitation were performed on the Ni- and Co-enriched solutions, respectively. The alkaline precipitation was conducted by incrementally adding 0.02 mL of 5 M NaOH into the Ni-enriched solution. After each addition, the suspension was stirred for 2 min for pH stabilization. When the pH was raised to 10.00, the suspension was centrifuged at 5000 rpm for 5 min. Sulfide precipitation of the Co-enriched solution was conducted following the similar procedures described in section 2.2.3. Elemental contents of Ni and Co in the corresponding precipitates were calculated based on the elemental composition of the feed solutions and the raffinates after precipitation.

### 2. Results and Discussion

### 2.1 Sample Characterization

Elemental concentrations and pH of the AMD are shown in Table 1. The AMD had a pH of 2.40, and the dominant metals present in the solution were Fe (389.28 mg/L), Al (422.54 mg/L), Ca (460.78 mg/L), and Mg (325.65 mg/L). In addition, the solution contained 64.36 mg/L Mn, 1.81 mg/L Co, and 5.35 mg/L Ni, which have been codified as critical elements by the U.S. Department of the Interior and the U.S. Department of Energy (Petty, 2018; US DOE, 2021). Besides the critical elements, trace amounts of other valuable elements, such as 1.77 mg/L Cu and 56.96 mg/L Zn, also existed in the solution. Therefore, the AMD is a promising source of valuable elements, particularly critical elements. In the present study, staged precipitation and re-dissolution, sulfide precipitation, calcination, sulfide precipitate dissolution, solvent extraction and stripping, and final products generation tests were performed on the AMD to produce high-purity products of the critical elements (i.e., Mn, Co, and Ni). Experimental results of these tests are presented and discussed in the following sections.

TABLE 1
Elemental concentrations (mg/L) and pH of the AMD.

| Element | Mn | Co | Ni | Zn | Cu | Fe | Al | Ca | Mg | Sulfate | pH |
|---|---|---|---|---|---|---|---|---|---|---|---|
| Concentration | 64.36 | 1.81 | 5.35 | 56.96 | 1.77 | 389.28 | 422.54 | 460.78 | 325.65 | 7,600 | 2.40 |

### 2.2 Staged Precipitation Tests

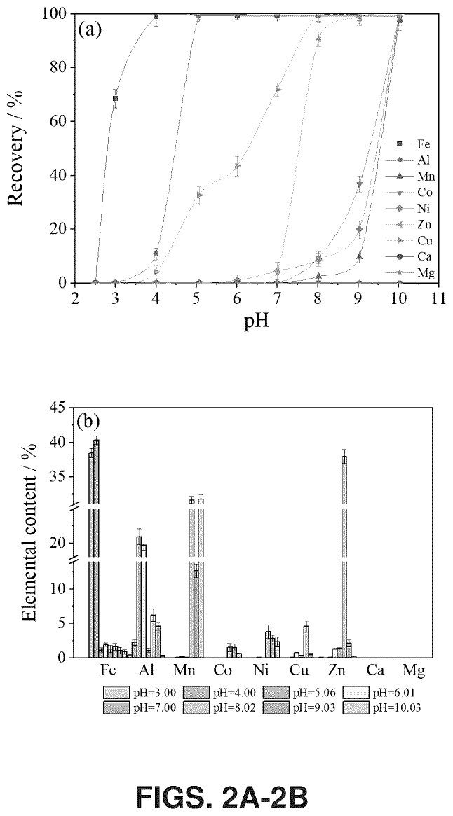

Staged precipitation tests were performed on the AMD to investigate the precipitation characteristics of the contaminant and valuable elements. Changes in the precipitation recovery of the elements as a function of pH are shown in FIG. 2(a). As one of the major contaminant elements, 68.54% of Fe was precipitated at pH 3.00, and it was almost completely removed from the solution at pH 4.00. After completely removing Fe from the solution at pH 4.00, further increases in the pH led to rapid precipitation of Al. Almost 100% of Al was precipitated when the pH raised to 5.06, under which condition only 32.74% of Cu was precipitated. Therefore, Fe and Al can be effectively removed from the solution by staged precipitation without considerable loss of the valuable elements. Other contaminant elements, i.e., Ca²⁺ and Mg²⁺, remained in the solution until the pH was above 10.00. Among the valuable elements, only Cu was predominantly precipitated in the pH range of 4.00 to 7.00. The other valuable elements started to precipitate at pH above 7.00. The precipitation recovery of Zn rapidly increased from 4.39% to 90.67% as pH raised from 7.00 to 8.02, and nearly 100% of the Zn was recovered from the solution at pH 9.03. The precipitation of Mn, Co, and Ni occurred in the pH range of 7.00-10.03. At pH 8.02, less than 10% of Mn, Co, and Ni were recovered, whereas when the pH was elevated to 10.03, almost 100% of the three critical elements were recovered. As such, a multi-element pre-concentrate is likely obtained by collecting the precipitates formed within an appropriate pH range.

A total of eight precipitates were obtained during the staged precipitation test. All the precipitates were digested, and the resulting digestion solutions were subjected to ICP-MS analysis to measure contaminant and valuable element contents. As shown in FIG. 2(b), Fe was the major component in the precipitates obtained at pH 3.00 and 4.00, while Al was the major component in the precipitates collected at pH 5.06 and 6.01. These findings are consistent with the precipitation recoveries shown in FIG. 2 (a). However, since the concentration of Fe and Al in the AMD is much higher than that of the valuable elements, certain amounts of Fe and Al still presented in the precipitates formed at pH values greater than 6.01. The critical elements mainly existed in the precipitates collected at pH 8.02, 9.03, and 10.03.

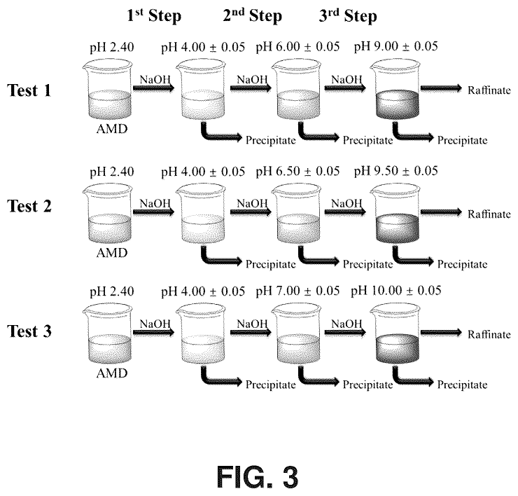

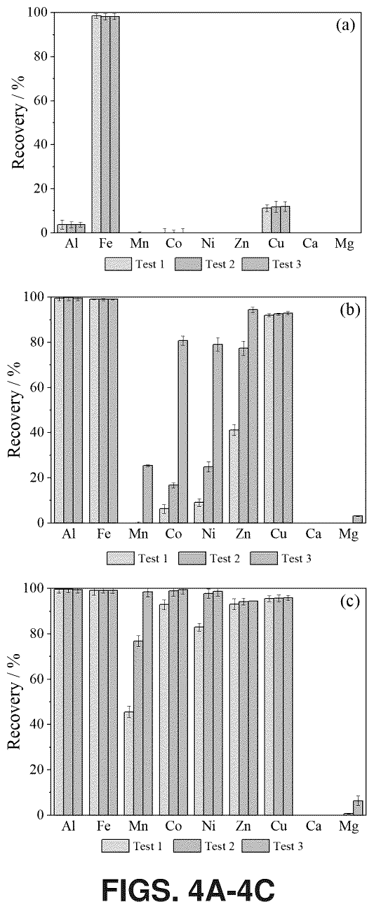

Based on the staged precipitation test results presented in FIG. 2, three tests were designed to determine the optimum pH range for generating a preconcentrate of the critical elements. As shown in FIG. 3, all the tests consisted of three steps: iron removal (1^{st} step), aluminum removal (2^{nd} step), and pre-concentrate generation (3^{rd} step). In each step, certain metal ions were precipitated as the pH increased by adding NaOH, and then the resulting precipitates were collected by solid/liquid separation. A final pH of around 4.00 was used for the first step of all the three tests, while for the second and third steps, different final pH values were used. Precipitation recoveries of the contaminant and valuable elements as a function of pH obtained from the three tests are shown in FIG. 4. For all the tests, nearly 100% of Fe was precipitated in the first step with minimal loss of the critical materials. However, around 11% of Cu was recovered along with the Fe precipitates at pH 4.00. This phenomenon is in accordance with a finding from previous research, that is, Cu can be adsorbed onto the surface of sulfate-rich Fe oxyhydroxides formed in AMD (Webster et al., 1998).

By raising the pH to around 6.00 or higher, almost 100% of Al was precipitated in the second step of all three tests. However, in the second test, around 20% of Co was precipitated together with Al, indicating that only 80% of Co can be recovered in the pre-concentrate generated in the third step. In the second step of the third test, a higher final pH of around 7.00 was used, and as such, more Co was precipitated with Al. This phenomenon is in contrast with the staged precipitation test results shown in FIG. 2. In the staged precipitation tests, the precipitation recovery of Co at a pH of around 7.00 was negligible. The contrast can be explained by the fact that in the staged precipitation tests, most Al precipitates were removed at pH around 6.00, while in the second step of the second and third tests shown in FIG. 3, Al precipitates still existed in the solutions, providing active sites for Co adsorption (Ayora et al., 2016; Bibak, 1994). Therefore, instead of precipitation, Co was more likely removed from the solutions through adsorption. Due to the same reason as Co, around 25% and 80% of Ni were removed in the second step of the second and third tests, respectively. Unlike Co and Ni, Mn was not removed in the second step of the second test. Therefore, the optimum final pH for Al removal in the second step was around pH 6.00; however, another group of critical elements, rare earth elements (REEs), were precipitated at this pH, causing difficulties in separating the REEs from Co, Mn, and Ni. Therefore, a higher pH of around 6.50 was selected for Al removal, and in this case, all the REEs together with around 20% of Co and 25% of Ni were recovered in the second step, while the majority of Co, Mn, and Ni were recovered in the third step. A process for REE recovery from AMD through staged precipitation has been published by the authors (Zhang and Honaker, 2018); therefore, REEs were excluded from the scope of the present study.

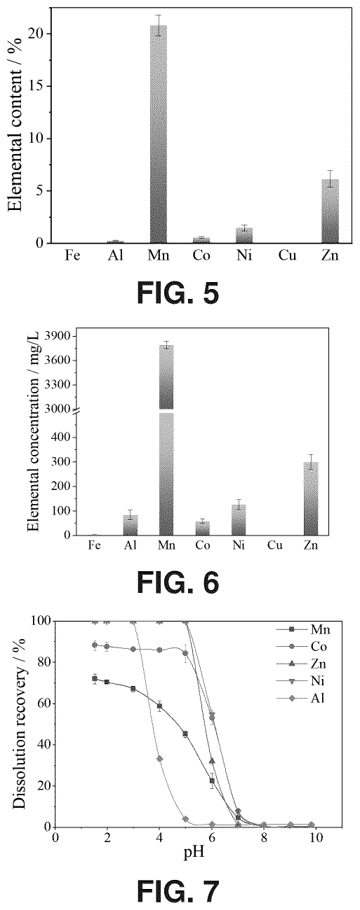

Comparisons among recoveries of the critical elements in the third step of the three tests suggested that a pH of around 10.00 was required to achieve 100% recovery of Mn (FIG. 4(c)). Overall, based on the results of the three tests, it can be concluded that pH 6.50-10.00 is the optimum range for obtaining satisfactory recoveries of Mn, Co, and Ni, while the recovery of Fe and Al was minimal. A pre-concentrate was generated by removing the precipitates formed at pH below 6.50 while collecting the precipitates formed in the pH range of 6.50 to 10.00. As shown in FIG. 5, Mn, Co, Ni, and Zn were abundant in the pre-concentrate with a content of 20.80%, 0.55%, 1.49%, and 6.15%, respectively. However, although almost 100% of Al was precipitated and removed at pH below 6.50, due to the relatively high concentration of Al in the AMD, there was still 0.26% of Al presenting in the pre-concentrate.

### 2.3 Re-Dissolution Test

To further purify the critical elements, a pre-concentrated slurry was produced by collecting the precipitates formed in 10 L of the AMD in the pH range of 6.50 to 10.00. The process for preparing the pre-concentrated slurry is shown in FIG. 1. As FIG. 6 shows, the slurry contained 3,794 mg/L Mn, 59 mg/L Co, 127 mg/L Ni, and 300 mg/L Zn, indicating a promising feed for critical elements and Zn recovery. However, the slurry also contained around 85 mg/L of Al, which may significantly influence the purity of final critical element products.

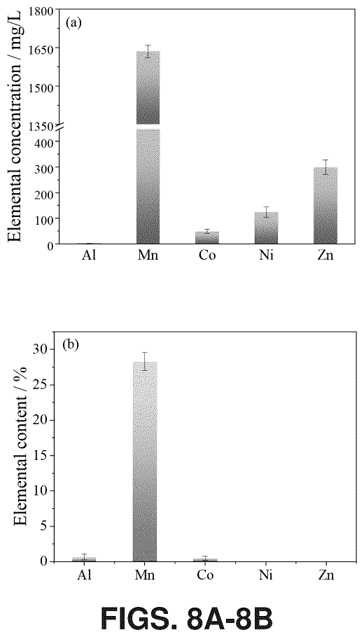

The precipitates in the pre-concentrated slurry were dissolved by adding HCl. Dissolution recoveries of Mn, Co, Ni, Zn, and Al are shown in FIG. 7. Fe and Cu were not considered since the concentration of the two elements in the slurry was minimal (less than 4 mg/L). As shown in FIG. 7, the critical elements and Zn started to dissolve at pH 7.00, and considerable dissolution occurred within a relatively small pH range of 7.00 to 4.99. Zn and Ni were totally dissolved at pH 4.99, while around 85% Co was dissolved at the same pH. The dissolution recovery of Co remained constant at around 85% with further decreases in the pH. The dissolution recovery of Mn was around 45% at pH 4.99, and the recovery continued to increase to 72% as the pH decreased to 1.51, indicating that stronger acidic conditions were needed to dissolve Mn than the other critical elements. Al started to dissolve at pH 4.99 and completely dissolved at pH 3.00. Based on differences in the dissolution characteristics among the elements, it can be concluded that by reducing the pH of the slurry to around 5.00, a solution rich in Co and Ni can be generated for further purification (FIG. 8(a)); meanwhile, more than 50% of Mn remained undissolved, which resulted in a high-purity Mn product (FIG. 8(b)). As shown in FIG. 8(b), Mn was the most dominant component of the undissolved solid with a content of about 30 wt. %, and this product contained less than 1% of Al and Co. As shown in FIG. 8(a), although less than 50% of Mn was dissolved at pH 5.00, around 1,600 mg/L of Mn presented in the solution, which was much higher than Co (50 mg/L) and Ni (124 mg/L). In addition, the re-dissolved solution also contained 300 mg/L of Zn, which was higher than the concentration of Co and Ni. Thereby, to get high-purity Co and Ni products, further treatment is required to reduce the content of Mn and Zn.

### 2.4 Sulfide Precipitation and Dissolution Tests

A solution rich in Mn, Co, Ni, and Zn was obtained after the re-dissolution step. As shown in FIG. 8(a), Mn was still the most abundant element in the solution. To effectively separate Mn from the other elements, sulfide precipitation tests were conducted to selectively precipitate Co, Ni, and Zn from the solution, and the reaction mechanisms can be expressed as the following equations:

$${Na}_{2} S + {Me}^{2 +} \to 2 {Na}^{+} + Me S \qquad Eq . ( 5 )$$

$${Na}_{2} S + {H}_{2} O \to 2 {Na}^{+} + {HS}^{-} + {OH}^{-} \qquad Eq . ( 6 )$$

$${HS}^{-} ↔ {H}^{+} + {S}^{2 -} \qquad Eq . ( 7 )$$

$${HS}^{-} + {Me}^{2 +} \to Me S + {H}^{+} \qquad Eq . ( 8 )$$

$${S}^{2 -} + {Me}^{2 +} \to Me S \qquad Eq . ( 9 )$$

As reported in the literature (Gharabaghi et al., 2012; Sampaio et al., 2009), sulfide precipitation has several advantages, particularly high selectivity towards certain elements, such as Co. The solubility of a solute in the solution can be represented by the solubility product constant, which is defined as Kₛₚ=[Me²⁺][S²⁻]. As Table 2 shows, the Kₛₚ of Mn sulfide at 25° C. is at least five orders of magnitude larger than that of the Co, Ni, and Zn sulfides, indicating that Mn sulfide is more soluble than the other metal sulfides. This contrast offers a theoretical basis for the separation of Mn from other valuable elements through sulfide precipitation.

TABLE 2
Solubility product constants of Mn, Co, Ni, and
Zn sulfides at 25° C. (Blais et al., 2008).

| Metal sulfides | Log Kₛₚ |
|---|---|
| MnS green | −12.6 |
| MnS pink | −9.6 |
| CoS alpha | −20.4 |
| NiS alpha | −18.5 |
| ZnS sphalerite | −23.0 |
| ZnS wurtzite | −24.3 |

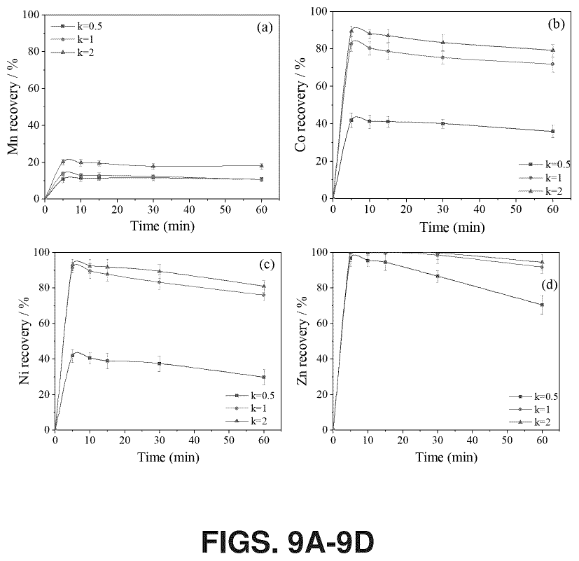

The impact of sulfur to metal molar ratio (k) was evaluated to optimize the selectivity of sulfide precipitation. The equations used to calculate k were described in section 2.2.3. The recoveries of Mn, Co, Ni, and Zn as a function of k and reaction time are presented in FIG. 9. As shown in the figure, rapid precipitation kinetics were observed for all the elements, with maximum recoveries being obtained within the first 5 min of reaction. However, with the prolongation of the reaction time, the recovery of all the elements decreased in varying degrees. This phenomenon has been observed in previous research (Karbanee et al., 2008; Lewis and Swartbooi, 2006). Luther et al. (1996) investigated the stability constants of metal-sulfide complexes. It was found that Mn, Fe, Ni, and Co form bisulfide complexes with stoichiometries of MSH⁺, M₂(SH)³⁺, and M₃(SH)⁵⁺, which dissociate below pH 7.00 with releasing H₂S. Therefore, it is essential to control the aging time of the sulfide precipitation process within 5 minutes. As shown in FIG. 9(a), the recovery of Mn was only around 10% when k was 0.5 and 1, and the recovery increased to around 20% when k was enhanced to 2. Compared with Mn, the recovery of Co and Ni shown in Figures(b) and (c) were much higher, and k considerably affected the recovery. Around 40% of Co and Ni were precipitated with a k of 0.5, while the recovery of Co and Ni increased to 80% and 90%, respectively, when k was enhanced to 1. Further increasing k to 2 did not significantly improve the recovery of Co and Ni. Comparing with Mn, Co, and Ni, the recovery of Zn was not greatly influenced by k, with around 100% recovery being achieved even with the lowest k of 0.5 (FIG. 9(d)). This phenomenon is in accordance with the fact that the Kₛp values of Zn sulfides shown in Table 2 were the smallest.

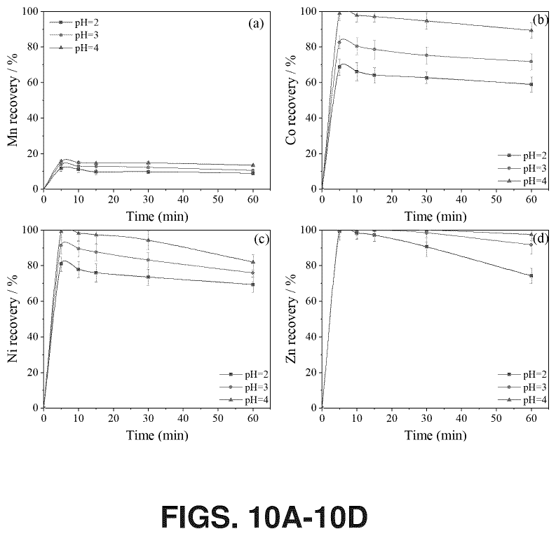

Besides the sulfur to metal molar ratio, pH also significantly influences the sulfide precipitation efficiency of metal ions. Therefore, in the present study, the effect of pH on the sulfide precipitation efficiency of Mn, Co, Ni, and Zn was evaluated. To avoid the formation of hydroxide precipitates, the tests were conducted at low pH values (i.e., 2.00, 3.00, 4.00). As presented in FIG. 10(a), around 10% of Mn was recovered at pH 2.00 after reacting for 5 min, and only small increases in the recovery were observed when the pH increased to 3.00 and 4.00. However, FIGS. 10(b) and (c) show that at pH 2.00, the highest recoveries of Co and Ni were 70% and 80%, respectively, and the recovery was significantly improved to around 100% when raising the pH to 4.00. FIG. 10(d) shows that pH imposed minor effects on Zn recovery, and 100% of the Zn was precipitated at all the three pH values after reacting for 5 min.

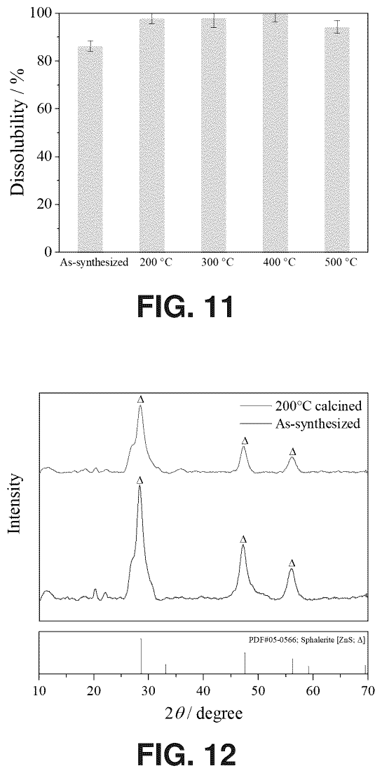

From the above results, it can be concluded that Co, Ni, and Zn were effectively separated from Mn at pH 4.00 with a k value of 1. Under these conditions, almost 100% Co, Ni, and Zn were precipitated, while the precipitation recovery of Mn was only around 15%. A bulk sulfide precipitate was obtained under these conditions. The precipitate was dissolved to achieve further separation and purification, and the resulting solution was subjected to solvent extraction. As reported in the literature (Aleksandrov et al., 2019), metal sulfides can be converted into more soluble forms using low-temperature sulphatizing or chlorinating calcination. Blank calcination without additives was also employed, which directly transformed the metal sulfides into metal oxides or sulfates (Yu et al., 2013). In the present study, calcination without any additives at various temperatures (i.e., 200° C., 300° C., 400° C., and 500° C.) was performed on the sulfide precipitate. As shown in FIG. 11, around 85% of the raw precipitate was dissolved in 1.2 M HCl; however, after calcination at 200° C. or higher for 2 h, nearly 100% of the precipitate was dissolved. From the economic perspective, the lowest temperature of 200° C. was chosen to calcine the sulfide precipitate for effective dissolution.

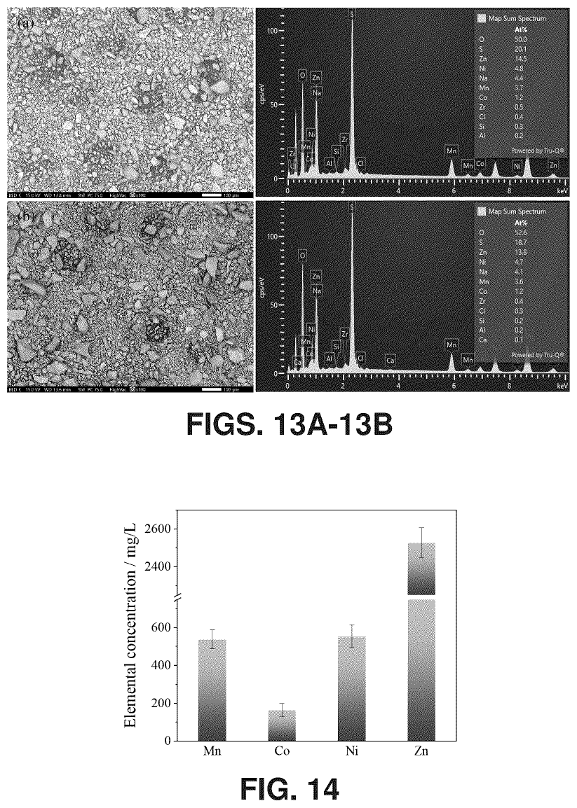

Mineralogical changes of the as-synthesized precipitate caused by blank calcination were characterized using XRD. As described in section 3.3, the concentration of Zn in the re-dissolved solution was much higher than that of Co and Ni (FIG. 8(a)). In addition, around 100% of Zn was precipitated in the sulfide precipitation process (FIG. 10(d)). Thereby, as FIG. 12 shows, sphalerite was identified as the dominant mineral phase in the sulfide precipitate. Co and Ni sulfide minerals were not identified due to their low contents. A comparison between the XRD patterns of the as-synthesized and 200° C.-calcined samples showed that the intensity of the sphalerite diffraction peaks decreased after calcination, indicating that the degree of crystallinity of the sphalerite decreased after calcination.

Elemental compositions of the as-synthesized and 200° C.-calcined sulfide precipitates were assessed through SEM-EDS analyses. Elemental mapping was conducted on four areas in the SEM specimen of each sample (i.e., as-synthesized and 200° C. calcined). The same elemental contents were obtained from the analysis of four areas; therefore, for each sample, the SEM image and EDS spectrum of only one area are presented in FIG. 13. From the EDS spectra and elemental compositions shown in FIG. 13(a), it can be observed that Zn was the dominant element in the sulfide precipitate with a content of about 14.5%. This phenomenon agreed with the XRD analysis result that sphalerite (ZnS) was the major mineral phase in the material (FIG. 12). As shown in FIG. 13(b), after being calcined at 200° C. for 2 h, the O content in the sulfide precipitate increased from 50.0% to 52.6%, and correspondingly, the sulfur content decreased from 20.1% to 18.7%, suggesting that a portion of the sulfide minerals in the precipitate were converted into sulfates during calcination. Overall, based on the XRD and SEM data, it can be concluded that calcination at 200° C. destroyed the crystal structure of sulfide minerals, thus leading to enhanced leachabilities.

### 2.5 Solvent Extraction and Stripping Tests

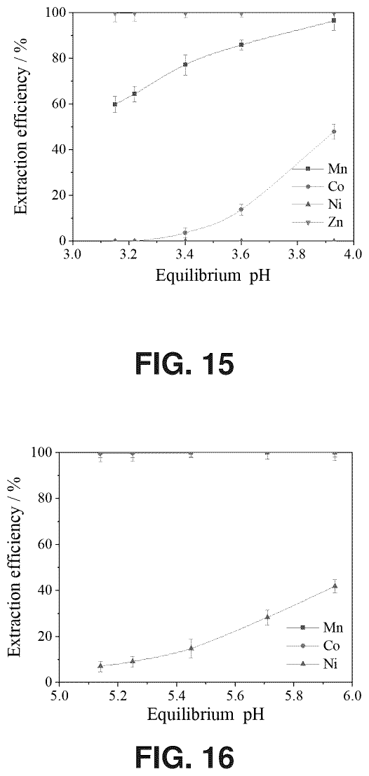

A solution rich in Mn, Co, Ni, and Zn was obtained by dissolving the sulfide precipitate in 1.2 M HCl. Elemental concentrations in the solution are shown in FIG. 14. To maximize the purity of the Co and Ni products, solvent extraction was utilized to selectively remove Mn and Zn from the solution and effectively separate Co from Ni. In previous research (Ahmadipour et al., 2011; Pereira et al., 2007), D2EHPA was applied to separate Zn and Mn; therefore, D2EHPA was applied in the current study to achieve the objectives. FIG. 15 shows the effect of the equilibrium pH of the aqueous phase on the extraction efficiency of Mn, Co, Ni, and Zn from the solution. In the pH range of 3.00 to 4.00, Zn was easily extracted with D2EHPA, and the extraction efficiency of Zn was 100% over the whole pH range. The extraction efficiency of Mn and Co increased as the equilibrium pH raised. At pH 3.15, around 60% of Mn was extracted, and the extraction efficiency of Mn increased to 96% when the pH raised to 3.93. As compared with Mn, Co started to be extracted at a higher pH of 3.40, and the extraction efficiency increased to around 50% at pH 3.93. Ni was not extracted in the pH range of 3.00 to 4.00. Thereby, D2EHPA could extract most Zn and around 80% of Mn at an equilibrium pH of around 3.40 from the solution, while the loss of Co and Ni was negligible. The extraction order was Zn>Mn>Co>Ni, which agrees with the results reported in the literature (Ahn et al., 2002; Cheng, 2000).

D2EHPA and Cyanex 272 have similar structures and have been used for Co/Ni separation in previous research (Devi et al., 1998; Reddy and Park, 2007). It is well-documented in the literature that the separation efficiency of Co from Ni using organophosphorus-based extractants increases in the order D2EHPA<PC 88A<Cyanex 272 (Darvishi et al., 2005). Therefore, after extracting Zn and Mn with D2EHPA in the first stage of solvent extraction, the aqueous phase was subjected to the second stage of solvent extraction using Cyanex 272 as the extractant to separate Co from Ni. The extraction process with Cyanex 272 was pH-dependent; therefore, the effect of equilibrium pH on the extraction efficiency was investigated. Because Zn was completely extracted in the first stage, the extraction efficiency of Zn was not considered in the second stage. As presented in FIG. 16, 100% of Mn and Co were extracted from the solution in the pH range of 5.00 to 6.00, and the equilibrium pH did not influence the extraction efficiency of Mn and Co; however, the recovery of Ni was increased with increases in the equilibrium pH. At an equilibrium pH of 5.14, around 7% of Ni was extracted, and when elevating the equilibrium pH value to 5.94, the recovery of Ni reached 42%. As such, cobalt and nickel were effectively separated with Cyanex 272 at equilibrium pH of 5.14. The Mn was coextracted with Co but can be separated with Co through sulfide precipitation.

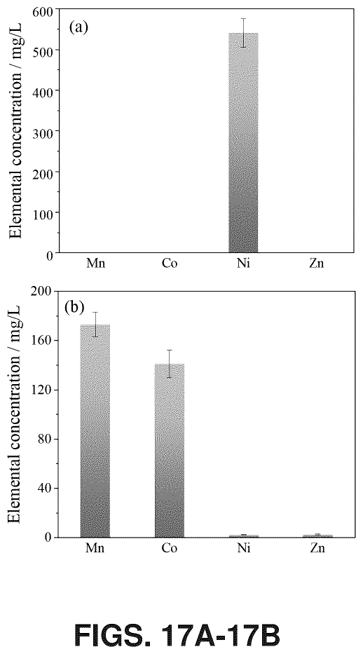

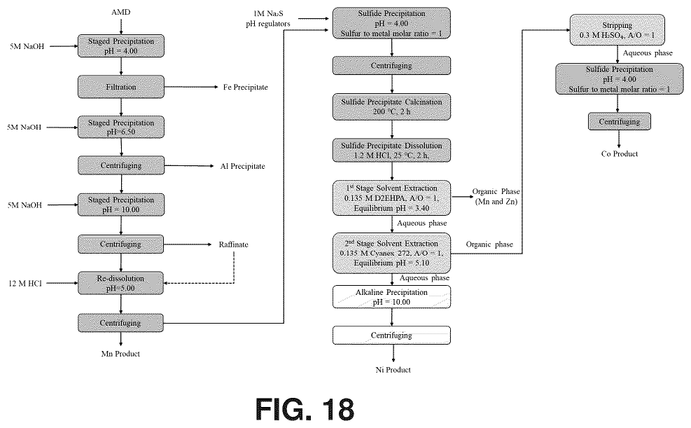

Based on the aforementioned results, a two-stage solvent extraction test was conducted on the solution obtained by dissolving the calcined sulfide precipitate. In the first stage, 100% of Zn and 70% of Mn were removed from the solution with 0.135 M D2EHPA at an equilibrium pH of 3.32. Co and Mn were extracted by 0.135 M Cyanex 272 at an equilibrium pH of 5.39 in the second stage while leaving Ni in the aqueous phase. As shown in FIG. 17(a), Ni was the only element in the aqueous phase after the second-stage solvent extraction, and the concentration of Mn, Co, and Zn was less than 1 mg/L. Co and Mn were in the organic phase; thereby, the organic phase was stripped with 0.3 M H₂SO₄, and elemental concentrations in the stripping solution are shown in FIG. 17(b). For producing a high-purity Co product, further treatment is needed to separate Mn and Co.

### 2.6 Production of Final Products

After the two-stage solvent extraction, Ni in the aqueous phase was precipitated by adding 5 M NaOH to increase the pH to 10.00. Based on elemental concentrations in the solution before and after precipitation (Table 3), it can be concluded that more than 99% of the Ni was precipitated, and the purity of the products was nearly 100% since Ni was the only valuable element detected in the solution. To produce a high-purity Co product, Mn and Co in the stripping solution were separated by sulfide precipitation, which was conducted at pH 4.00 with a sulfur to metal molar ratio of 1. Based on the elemental concentrations shown in Table 4, it could be calculated that more than 90% of Co was recovered from the solution; whereas, only 5% of Mn was precipitated. In addition, based on elemental concentrations in the solution before and after precipitation, the purity of the Co sulfide product was estimated to be around 93.6%.

TABLE 3
Elemental concentrations of Ni in the aqueous
phase before and after precipitation.

| Element | Ni |
|---|---|
| Concentration (before precipitation, mg/L) | 575.90 |
| Concentration (after precipitation, mg/L) | 2.25 |

TABLE 4
Elemental concentrations of Mn and Co in the solution
before and after sulfide precipitation.

| Element | Mn | Co |
|---|---|---|
| Concentration (before precipitation, mg/L) | 173.18 | 141.20 |
| Concentration (after precipitation, mg/L) | 164.46 | 14.14 |

### 2.7 Flowsheet Description

A process flowsheet was developed to generate high-purity products of certain critical elements (i.e., Mn, Co, and Ni) from AMD. As FIG. 18 shows, the primary contaminants, including Fe and Al, are initially removed by staged precipitation at pH 4.00 and 6.50, respectively. By further increasing the solution pH, a pre-concentrate of Mn, Co, Ni, and Zn is obtained in the pH range of 6.50-10.00. A slurry is then prepared by mixing the pre-concentrate with a small volume of the raffinate obtained from the third-stage precipitation. Around 100% of Ni and Zn, 85% of Co, and 45% of Mn are dissolved into solution by adding hydrochloric acid to decrease the pH of the slurry to approximately 5.00. The undissolved residue obtained from the re-dissolution process is an Mn-enriched product with high purity (30 wt. % Mn content). The solution containing re-dissolved elements was routed to a sulfide precipitation process to further separate Mn from the other critical elements. The sulfide precipitate is calcined and dissolved in hydrochloric acid for further purification using solvent extraction. The solvent extraction is performed in two stages, and D2EHPA and Cyanex 272 are used in the first- and second-stage, respectively. In the first stage, around 70% of Mn and 100% of Zn in the feed solution are extracted, resulting in a solution comprised of Co, Ni, and a small amount of Mn. In this case, the second stage solvent extraction is applied to separate Co and Ni. Co and Mn in the organic phase are stripped with sulfuric acid and further separated with sulfide precipitation to obtain a cobalt product. Ni in the aqueous phase is recovered by raising the pH to 10.00. Ni and Co products with ash high as 100% and 94% purity can be obtained using this flowsheet.

### 3. Conclusions

Systematic experimental tests were performed on an AMD to recover and purify Mn, Co, and Ni, which have been determined as critical elements by the U.S. Department of Interior and the U.S. Department of Energy. Major contaminants in the AMD were first precipitated and eliminated by raising the pH to around 6.50. Then, a pre-concentrated slurry containing 3,794 mg/L Mn, 59 mg/L Co, and 127 mg/L Ni, was obtained by collecting the precipitates formed in the pH range of 6.50 to 10.00. To purify the critical elements, re-dissolution tests were performed on the pre-concentrated slurry. It was found that the majority of Co and Ni were dissolved by reducing the pH to 5.00, while more than 50% of Mn remained undissolved, leading to a solid residue containing around 30 wt. % Mn. Sulfide precipitation tests were performed on the re-dissolved solution, and under optimum conditions, almost 100% of Co and Ni were precipitated, while the recovery of Mn was only around 15%. After calcination at 200° C. for 2 h, the sulfide precipitate generated under the optimum conditions was dissolved in a HCl solution. To separate the critical elements in the dissolved solution, a two-stage solvent extraction method was developed. Around 60% of Mn and 100% of Zn were extracted with D2EHPA in the first stage, while Co and Ni remained in the aqueous phase and were separated with Cyanex 272 in the second stage SX. Ultimately, Co and Ni products with almost 94% and 100% purity were obtained by sulfide and alkaline precipitation, respectively. Based on the results of the different tests, a process flowsheet was successfully developed to produce high-purity Mn, Co, and Ni products from AMD.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

Ahmadipour, M., Rashchi, F., Ghafarizadeh, B., Mostoufi, N., 2011. Synergistic effect of D2EHPA and cyanex 272 on separation of zinc and manganese by solvent extraction. Sep. Sci. Technol. 46, 2305-2312. https://doi.org/10.1080/01496395.2011.594848
Ahn, J. G., Park, K. H., Sohn, J. S., 2002. Solvent extraction separation of Co, Mn and Zn from Ni-rich leaching solution by Na-PC88A. Mater. Trans. 43, 2069-2072. https://doi.org/10.2320/matertrans.43.2069
Akcil, A., Koldas, S., 2006. Acid Mine Drainage (AMD): causes, treatment and case studies. J. Clean. Prod. 14, 1139-1145. https://doi.org/10.1016/j.jclepro.2004.09.006
Aleksandrov, P. V., Medvedev, A. S., Imideev, V. A., Moskovskikh, D. O., 2019. Nickel sulphide concentrate processing via low-temperature calcination with sodium chloride. Part 1—Identification of interaction products. Miner. Eng. 134, 37-53. https://doi.org/10.1016/J.MINENG.2019.01.001
Ayora, C., Macías, F., Torres, E., Lozano, A., Carrero, S., Nieto, J.-M., Pérez-López, R., Fernández-Martínez, A., Castillo-Michel, H., 2016. Recovery of Rare Earth Elements and Yttrium from Passive-Remediation Systems of Acid Mine Drainage. Environ. Sci. &amp; Technol. 50, 8255-8262. https://doi.org/10.1021/acs.est.6b02084
Bibak, A., 1994. Cobalt, copper, and manganese adsorption by aluminium and iron oxides and humic acid. Commun. Soil Sci. Plant Anal. 25, 3229-3239. https://doi.org/10.1080/00103629409369261
Blais, J. F., Djedidi, Z., Cheikh, R. B., Tyagi, R. D., Mercier, G., 2008. Metals precipitation from effluents: Review. Pract. Period. Hazardous, Toxic, Radioact. Waste Manag. 12, 135-149. https://doi.org/10.1061/(ASCE)1090-025X(2008)12:3(135)
Burger, M. H., Schmeda, G., Long, K. R., Reyes, T. A., Karl, N. A., 2018. Cobalt Deposits in the United States, U. S. Geological Survey data release. https://doi.org/https://doi.org/10.5066/P9V74HIU
Chen, T., Yan, B., Lei, C., Xiao, X., 2014. Pollution control and metal resource recovery for acid mine drainage. Hydrometallurgy 147, 112-119.
Cheng, C. Y., 2000. Purification of synthetic laterite leach solution by solvent extraction using D2EHPA. Hydrometallurgy 56, 369-386. https://doi.org/10.1016/S0304-386X(00)00095-5
Darvishi, D., Haghshenas, D. F., Alamdari, E. K., Sadrnezhaad, S. K., Halali, M., 2005. Synergistic effect of Cyanex 272 and Cyanex 302 on separation of cobalt and nickel by D2EHPA. Hydrometallurgy 77, 227-238. https://doi.org/10.1016/J.HYDROMET.2005.02.002
Devi, N. B., Nathsarma, K. C., Chakravortty, V., 1998. Separation and recovery of cobalt(II) and nickel(II) from sulphate solutions using sodium salts of D2EHPA, PC 88A and Cyanex 272. Hydrometallurgy 49, 47-61. https://doi.org/10.1016/S0304-386X(97)00073-X
Gharabaghi, M., Irannajad, M., Reza Azadmehr, A., 2012. Selective Sulphide Precipitation of Heavy Metals from Acidic Polymetallic Aqueous Solution by Thioacetamide. Ind. &amp; Eng. Chem. Res. 51, 954-963. https://doi.org/10.1021/ie201832x
Honaker, R. Q., Zhang, W., Yang, X., Rezaee, M., 2018. Conception of an integrated flowsheet for rare earth elements recovery from coal coarse refuse. Miner. Eng. 122, 233-240. https://doi.org/10.1016/j.mineng.2018.04.005
Karbanee, N., Van Hille, R. P., Lewis, A. E., 2008. Controlled Nickel Sulfide Precipitation Using Gaseous Hydrogen Sulfide. Ind. Eng. Chem. Res. 47. https://doi.org/10.1021/ie0711224
Larsson, M., Nosrati, A., Kaur, S., Wagner, J., Baus, U., Nyden, M., 2018. Copper removal from acid mine drainage-polluted water using glutaraldehyde-polyethyleneimine modified diatomaceous earth particles. Heliyon 4, e00520. https://doi.org/10.1016/j.heliyon.2018.e00520
Lewis, A., Swartbooi, A., 2006. Factors affecting metal removal in mixed sulfide precipitation. Chem. Eng. Technol. 29, 277-280. https://doi.org/10.1002/ceat.200500365
Lewis, A., Van Hille, R., 2006. An exploration into the sulphide precipitation method and its effect on metal sulphide removal. Hydrometallurgy 81, 197-204. https://doi.org/10.1016/j.hydromet.2005.12.009
Lewis, A. E., 2010. Review of metal sulphide precipitation. Hydrometallurgy 104, 222-234. https://doi.org/10.1016/j.hydromet.2010.06.010
Liu, W., Sun, B., Zhang, D., Chen, L., Yang, T., 2017. Selective Separation of Similar Metals in Chloride Solution by Sulfide Precipitation Under Controlled Potential. Miner. Met. Mater. Soc. 69, 2358-2363. https://doi.org/10.1007/s11837-017-2526-0
Macingova, E., Luptakova, A., 2012. Recovery of Metals from Acid Mine Drainage Recovery of Metals from Acid Mine Drainage. Chem. Eng. Trans. 28.
Motsi, T., Rowson, N. A., Simmons, M. J. H., 2009. Adsorption of heavy metals from acid mine drainage by natural zeolite. Int. J. Miner. Process. 92, 42-48. https://doi.org/10.1016/j.minpro.2009.02.005
Nadimi, H., Haghshenas Fatmehsari, D., Firoozi, S., 2017. Separation of Ni and Co by D2EHPA in the Presence of Citrate Ion. Metall. Mater. Trans. B Process Metall. Mater. Process. Sci. 48, 2751-2758. https://doi.org/10.1007/s11663-017-1008-7
Oh, C., Han, Y.-S., Park, J. H., Bok, S., Cheong, Y., Yim, G., Ji, S., 2016. Field application of selective precipitation for recovering Cu and Zn in drainage discharged from an operating mine. Sci. Total Environ. 557, 212-220.
Olushola, S. A., a, Folahan, A. A., Alafara, A. B., Bhekumusa, J. X., Olalekan, S. F., 2013. Application of Cyanex extractant in Cobalt/Nickel separation process by solvent extraction. Int. J. Phys. Sci. 8, 89-97. https://doi.org/10.5897/ijps12.135
Omelchuk, K., Szczepahski, P., Shrotre, A., Haddad, M., Chagnes, A., 2017. Effects of structural changes of new organophosphorus cationic exchangers on a solvent extraction of cobalt, nickel and manganese from acidic chloride media. RSC Adv. 7, 5660-5668. https://doi.org/10.1039/c6ra21695a
Park, S. M., Shin, S. Y., Yang, J. S., Ji, S. W., Baek, K., 2015a. Selective Recovery of Dissolved Metals from Mine Drainage Using Electrochemical Reactions. Electrochim. Acta 181, 248-254. https://doi.org/10.1016/j.electacta.2015.03.085
Park, S. M., Yoo, J. C., Ji, S. W., Yang, J. S., Baek, K., 2015b. Selective recovery of dissolved Fe, Al, Cu, and Zn in acid mine drainage based on modeling to predict precipitation pH. Environ. Sci. Pollut. Res. 22, 3013-3022. https://doi.org/10.1007/s11356-014-3536-x
Pereira, D. D., Rocha, S. D. F., Mansur, M. B., 2007. Recovery of zinc sulphate from industrial effluents by liquid-liquid extraction using D2EHPA (di-2-ethylhexyl phosphoric acid). Sep. Purif. Technol. 53, 89-96. https://doi.org/10.1016/J.SEPPUR.2006.06.013
Petty, T. R., 2018. Final List of Critical Minerals 2018. Fed. Regist. 83, 23295-23296.
Pozo, G., Pongy, S., Keller, J., Ledezma, P., Freguia, S., 2017. A novel bioelectrochemical system for chemical-free permanent treatment of acid mine drainage. Water Res. 126, 411-420. https://doi.org/10.1016/j.watres.2017.09.058
Reddy, B. R., Park, K. H., 2007. Process for the recovery of cobalt and nickel from sulphate leach liquors with saponified Cyanex 272 and D2EHPA. Sep. Sci. Technol. 42, 2067-2080. https://doi.org/10.1080/01496390701310496
Sahinkaya, E., Gungor, M., Bayrakdar, A., Yucesoy, Z., Uyanik, S., 2009. Separate recovery of copper and zinc from acid mine drainage using biogenic sulfide. J. Hazard. Mater. 171, 901-906. https://doi.org/10.1016/j.jhazmat.2009.06.089
Sampaio, R. M. M., Timmers, R. A., Kocks, N., André, V., Duarte, M. T., Van Hullebusch, E. D., Farges, F., Lens, P. N. L., 2010. Zn—Ni sulfide selective precipitation: The role of supersaturation. Sep. Purif. Technol. 74, 108-118. https://doi.org/10.1016/J.SEPPUR.2010.05.013
Sampaio, R. M. M., Timmers, R. A., Xu, Y., Keesman, K. J., Lens, P. N. L., 2009. Selective precipitation of Cu from Zn in a pS controlled continuously stirred tank reactor. J. Hazard. Mater. 165, 256-265.
Seo, E. Y., Cheong, Y. W., Yim, G. J., Min, K. W., Geroni, J. N., 2017. Recovery of Fe, Al and Mn in acid coal mine drainage by sequential selective precipitation with control of pH. Catena 148, 11-16.
Skousen, J. G., Ziemkiewicz, P. F., McDonald, L. M., 2019. Acid mine drainage formation, control and treatment: Approaches and strategies. Extr. Ind. Soc. 6, 241-249. https://doi.org/10.1016/j.exis.2018.09.008
Supattarasakda, K., Petcharoen, K., Permpool, T., Sirivat, A., Lerdwijitjarud, W., 2013. Control of hematite nanoparticle size and shape by the chemical precipitation method. Powder Technol. 249, 353-359. https://doi.org/10.1016/j.powtec.2013.08.042
Tsakiridis, P. E., Agatzini-Leonardou, S., 2005. Solvent extraction of aluminium in the presence of cobalt, nickel and magnesium from sulphate solutions by Cyanex 272. Hydrometallurgy 80, 90-97. https://doi.org/10.1016/J.HYDROMET.2005.07.002
US DOE, 2021. DOE Announces $30 Million for Research to Secure Domestic Supply Chain of Critical Elements and Minerals [WWW Document]. URL https://www.energy.gov/articles/doe-announces-30-million-research-secure-domestic-supply-chain-critical-elements-and
Vaziri Hassas, B., Rezaee, M., Pisupati, S. V., 2020. Precipitation of rare earth elements from acid mine drainage by C02 mineralization process. Chem. Eng. J. 399, 125716. https://doi.org/10.1016/j.cej.2020.125716
W. Luther, G., T. Rickard, D., Theberge, S., Olroyd, A., 1996. Determination of Metal (Bi)Sulfide Stability Constants of Mn2+, Fe2+, Co2+, Ni2+, Cu2+, and Zn2+ by Voltammetric Methods. Environ. Sci. &amp; Technol. 30, 671-679. https://doi.org/10.1021/es950417i
Webster, J. G., Swedlund, P. J., Webster, K. S., 1998. Trace metal adsorption onto an acid mine drainage iron(III) oxy hydroxy sulfate. Environ. Sci. Technol. 32, 1361-1368. https://doi.org/10.1021/es9704390
Yu, D., Utigard, T. A., Barati, M., 2013. Fluidized Bed Selective Oxidation-Sulfation Roasting of Nickel Sulfide Concentrate: Part II. Sulfation Roasting, in: The Minerals, Metals & Materials Society. https://doi.org/10.1007/s11663-013-9959-9
Zhang, W., Honaker, R., 2020. Process development for the recovery of rare earth elements and critical metals from an acid mine drainage. Miner. Eng. Minor Revi.
Zhang, W., Honaker, R. Q., 2018. Rare earth elements recovery using staged precipitation from a leachate generated from coarse coal refuse. Int. J. Coal Geol. 195, 189-199. https://doi.org/10.1016/j.coal.2018.06.008

1. A method for recovering manganese ions from a leach solution, the method comprising:
(a) optionally mixing the leach solution with an oxidant to produce a first composition;
(b) adding a base to the first composition or to the leach solution to produce a second composition, wherein the second composition comprises a second supernatant and a second precipitate;
(c) separating the second supernatant from the second composition;
(d) adding a base to the second supernatant to produce a third composition, wherein the third composition comprises a third supernatant and a third precipitate;
(e) separating the third supernatant from the third composition;
(f) adding a base to the third supernatant to produce a fourth composition, wherein the fourth composition comprises a fourth supernatant and a fourth precipitate;
(g) separating the fourth precipitate from the fourth composition;
(h) adding an acid to the fourth precipitate to produce a fifth composition, wherein the fifth composition comprises a fifth supernatant and a fifth precipitate; and
(i) separating the fifth precipitate from the fifth composition, wherein the fifth precipitate is enriched with manganese ions.

2. The method of claim 1, wherein the oxidant comprises hydrogen peroxide or oxygen.

3. The method of claim 1, wherein the base comprises an alkali metal hydroxide or alkaline earth hydroxide.

4. The method of claim 1, wherein the base comprises sodium hydroxide.

5. The method of claim 1, wherein the base comprises sodium hydroxide at a concentration of about 4 M to 6 M.

6. The method of claim 1, wherein the base has a concentration of from about 1 M to about 10 M.

7. The method of claim 1, wherein the second composition has a pH of about 3 to about 4.5.

8. The method of claim 1, wherein the third composition has a pH of about 6 to about 7.

9. The method of claim 1, wherein the fourth composition has a pH of about 9.5 to about 10.5.

10. The method of claim 1, wherein the acid comprises hydrochloric acid, sulfuric acid, phosphoric acid, nitric acid, or any combination thereof.

11. The method of claim 1, wherein the acid has a concentration of from about 5 M to 15 M.

12. The method of claim 1, wherein the acid is hydrochloric acid having a concentration of from about 10 M to 13 M.

13. The method of claim 1, wherein steps (c), (e), (g), and (i) are performed by centrifugation, filtration, or other solid/liquid separation methods.

14. The method of claim 1, wherein the fourth precipitate comprises a slurry.

15. A method for recovering nickel ions from a leach solution, the method comprising:
(a) mixing the fifth supernatant produced by the method of claim 1 with a sulfide source to produce a sixth composition comprising a sixth supernatant and a sixth precipitate;
(b) separating the sixth precipitate from the sixth composition;
(c) calcining the sixth precipitate;
(d) dissolving the sixth precipitate in an acid to produce a seventh composition;
(e) extracting the seventh composition with a first extractant to produce an eighth composition comprising a first aqueous phase and a first organic phase;
(f) separating the first aqueous phase from the eighth composition;
(g) adding a base to the first aqueous phase to produce a tenth composition, wherein the tenth composition comprises a tenth supernatant and a tenth precipitate;
(h) separating the tenth precipitate from the tenth composition, wherein the tenth precipitate is enriched with nickel ions.

16. The method of claim 15, wherein the sulfide source comprises an alkali metal sulfide or an alkaline earth sulfide.

17. The method of claim 15, wherein the sulfide source is in a molar ratio of from about 0.5:1 to about 1.5:1 sulfide source to critical metal ions.

18. The method of claim 15, wherein the sulfide source is sodium sulfide.

19. The method of claim 15, wherein the sixth composition has a pH of from about 3.5 to about 4.5.

20. The method of claim 15, wherein the sixth precipitate is calcined at a temperature of from about 100° C. to about 500° C.

21. The method of claim 15, wherein the sixth precipitate is dissolved in hydrochloric acid, sulfuric acid, phosphoric acid, nitric acid, or any combination thereof.

22. The method of claim 15, wherein the first aqueous phase in step (e) has a pH of from about 3 to about 4.

23. The method of claim 15, wherein the first extractant comprises a phosphate compound.

24. The method of claim 15, wherein the first extractant comprises an alkyl phosphate or an aryl phosphate.

25. The method of claim 15, wherein the first extractant comprises an alkyl phosphinic acid or an aryl phosphinic acid.

26. The method of claim 15, wherein the first extractant comprises an alkyl phosphine oxide or an aryl phosphine oxide.

27. The method of claim 15, wherein the first extractant comprises bis(2,4,4-trimethylpentyl) phosphinic acid, bis(2,4,4-trimethylpentyl)dithiophosphinic acid, trioctylphosphine oxide, dioctylmonohexylphosphine oxide, dihexylmonooctylphosphine oxide, trihexylphosphine oxide, bis-(2,4,4-trimethylpentyl) monothiophosphinic acid, di-(2-ethylhexyl) phosphinic acid, 2-ethylhexyl 2-ethylhexyphosphonic acid, neodecanoic acid, or any combination thereof.

28. The method of claim 15, wherein the base comprises an alkali metal hydroxide or alkaline earth hydroxide.

29. The method of claim 15, wherein the base comprises sodium hydroxide.

30. The method of claim 15, wherein the amount of base added in step (g) is sufficient to produce a pH of about 9.5 to about 10.5.

31. The method of claim 15, comprising
(a) mixing the fifth supernatant with a sulfide source to produce a sixth composition comprising a sixth supernatant and a sixth precipitate;
(b) separating the sixth precipitate from the sixth composition;
(c) calcining the sixth precipitate;
(d) dissolving the sixth precipitate in an acid to produce a seventh composition;
(e) extracting the seventh composition with a first extractant to produce an eighth composition comprising a first aqueous phase and a first organic phase;
(f) separating the first aqueous phase from the eighth composition;
(g) extracting the first aqueous phase with a second extractant to produce a ninth composition comprising a second aqueous phase and a second organic phase;
(h) separating the second aqueous phase from the ninth composition;
(i) adding a base to the second aqueous phase to produce a tenth composition, wherein the tenth composition comprises a tenth supernatant and a tenth precipitate;
(j) separating the tenth precipitate from the tenth composition, wherein the tenth precipitate is enriched with nickel ions.

32. The method of claim 31, wherein the sulfide source comprises an alkali metal sulfide or an alkaline earth sulfide.

33. The method of claim 31, wherein the sulfide source is in a molar ratio of from about 0.5:1 to about 1.5:1 sulfide source to critical metal ions.

34. The method of claim 31, wherein the sulfide source is sodium sulfide.

35. The method of claim 31, wherein the sixth composition has a pH of from about 3.5 to about 4.5.

36. The method of claim 31, wherein the sixth precipitate is calcined at a temperature of from about 100° C. to about 500° C.

37. The method of claim 31, wherein the sixth precipitate is dissolved in hydrochloric acid, sulfuric acid, phosphoric acid, nitric acid, or any combination thereof.

38. The method of claim 31, wherein the first aqueous phase in step (e) has a pH of from about 3 to about 4.

39. The method of claim 31, wherein the second aqueous phase in step (g) has a pH of from about 5.0 to about 6.0.

40. The method of claim 31, wherein the base comprises an alkali metal hydroxide or alkaline earth hydroxide.

41. The method of claim 31, wherein the base comprises sodium hydroxide.

42. The method of claim 31, wherein the amount of base added in step (i) is sufficient to produce a pH of about 9.5 to about 10.5.

43. The method of claim 31, wherein the first extractant and the second extractant are the same compound.

44. The method of claim 31, wherein the first extractant and the second extractant are different compounds.

45. The method of claim 31, wherein the first extractant and the second extractant comprises a phosphate compound.

46. The method of claim 31, wherein the first extractant and the second extractant comprises an alkyl phosphate or an aryl phosphate.

47. The method of claim 31, wherein the first extractant and the second extractant comprises an alkyl phosphinic acid or an aryl phosphinic acid.

48. The method of claim 31, wherein the first extractant and the second extractant comprises an alkyl phosphine oxide or an aryl phosphine oxide.

49. The method of claim 31, wherein the first extractant and the second extractant comprises bis(2,4,4-trimethylpentyl) phosphinic acid, bis(2,4,4-trimethylpentyl)dithiophosphinic acid, trioctylphosphine oxide, dioctylmonohexylphosphine oxide, dihexylmonooctylphosphine oxide, trihexylphosphine oxide, bis-(2,4,4-trimethylpentyl) monothiophosphinic acid, di-(2-ethylhexyl) phosphinic acid, 2-ethylhexyl 2-ethylhexyphosphonic acid, neodecanoic acid, or any combination thereof.

50. The method of claim 31, wherein the first extractant is bis(2-ethylhexyl) phosphate (D2EHPA).

51. The method of claim 31, wherein the second extractant is bis(2,4,4-trimethylpentyl) phosphinic acid (Cyanex 272).

52. The method of claim 31, wherein steps (b) and (j) are performed by centrifugation, filtration, or other solid/liquid separation methods.

53. A method for recovering cobalt ions from a leach solution, the method comprising:
(a) mixing the second organic phase produced by the method of claim 15 with an acid to produce an eleventh composition;
(b) mixing the eleventh composition with a sulfide source to produce a twelfth composition comprising a twelfth supernatant and a twelfth precipitate; and
(c) separating the twelfth precipitate from the twelfth composition, wherein the twelfth precipitate is enriched with cobalt ions.

54. The method of claim 53, wherein the acid comprises hydrochloric acid, sulfuric acid, phosphoric acid, nitric acid, or any combination thereof at a concentration of from about 0.1 M to 1 M.

55. The method of claim 53, wherein the sulfide source comprises an alkali metal sulfide or an alkaline earth sulfide.

56. The method of claim 53, wherein the sulfide source is in a molar ratio of from about 0.5:1 to about 1.5:1 sulfide source to the sum of cobalt ions and manganese ions.

57. The method of claim 53, wherein the sulfide source is sodium sulfide.

58. The method of claim 53, wherein the eleventh composition has a pH of from about 3.5 to about 4.5.

59. The method of claim 53, wherein step (c) performed by centrifugation, filtration, or other solid/liquid separation methods.

60. The method of claim 1, wherein the leach solution comprises clean coal leachate, coal refuse leachate, acid mine drainage, or a solution comprising a matrix as the coal-based leachate.
